(19) United States
(12) Patent Application Publication
(10) Pub. No.: US 2020/0304892 A1
(43) Pub. Date: Sep. 24, 2020

(54) Smart Device Systems and Methods for Providing High Fidelity Audio and Wireless Communications and Control

(71) Applicant: WAWLEE, INC., Lewes, DE (US)

(72) Inventor: Nick PAWSON, Rehoboth Beach, DE (US)

(73) Assignee: WAWLEE, INC., Lewes, DE (US)

(21) Appl. No.: 16/826,100

(22) Filed: Mar. 20, 2020

Related U.S. Application Data
(60) Provisional application No. 62/821,827, filed on Mar. 21, 2019.
(60) Provisional application No. 62/924,153, filed on Oct. 21, 2019.

(51) Int. Cl. H04R 1/02

(52) U.S. Cl. CPC H04R 1/025; H04R 2201/028

(57) ABSTRACT

The present disclosure provides a smart device system for providing high fidelity audio and wireless communications and control. In an exemplary embodiment, the smart device system comprises a smart device, that includes an amplifier module configured for processing digital and analog data for producing high fidelity audio, a microcontroller unit module configured for wireless communications and control, at least one speaker communicatively coupled to the amplifier module, at least one microphone communicatively coupled to the microcontroller unit, a smart device enclosure, a smart device electrical connector, a smart device mechanical connector, a smart device anti-vibration element, and a smart device user input component. The present disclosure further provides a method for providing high fidelity audio and wireless communications and control using a smart device.

### CROSS REFERENCE TO RELATED APPLICATION(S)

This application claims priority to U.S. provisional application No. 62/821,827, filed on Mar. 21, 2019, and to U.S. provisional application No. 62/924,153, filed on Oct. 21, 2019. The entire contents of the above identified applications are incorporated herein by reference as if fully set forth herein.

### TECHNICAL FIELD

The present disclosure relates to smart device systems and methods for providing high fidelity audio and wireless communications and control.

### BACKGROUND

Home automation devices are becoming increasingly prevalent as consumers wish to wirelessly integrate various features of their home. Many activities, which formerly required physical movement to complete (e.g., turning on or off the lights, checking if a door or window is closed, playing music), are now completed without the user's physical movement. For example, the user may initiate the activity by using a smart phone application or by providing a voice command to a smart device.

Many of these smart systems and devices require complicated set-up procedures, must be wired to particular devices or outlets, and have limits on which other smart devices can be communicated with. Many of these constraints and requirements of conventional smart systems and devices create an entrance barrier to the technology for consumers who are not tech-savvy, whose patience setting-up the system or device outweighs the expected benefit, or who do not have the desire or, in some cases, the rights to perform the necessary construction/renovation work required for installation.

Furthermore, many of these conventional smart devices take up counter and tabletop space, which may be limited or better utilized for other items, as well as power outlets, generally interfering with the lifestyle of a consumer.

### SUMMARY

In response to these and other limitations of conventional smart systems and devices, the present disclosure provides a smart device system for providing high fidelity audio and wireless communications and control. In an exemplary embodiment, the smart device system comprises a smart device, that includes an amplifier module configured for processing digital and analog data for producing high fidelity audio, a microcontroller unit module configured for wireless communications and control, at least one speaker communicatively coupled to the amplifier module, at least one microphone communicatively coupled to the microcontroller unit, a smart device enclosure, a smart device electrical connector, a smart device mechanical connector, a smart device anti-vibration element, and a smart device user input component.

In an exemplary embodiment, the smart device system also includes a power management unit, that includes a power management module configured for supplying power to the smart device, a power management unit enclosure, a power management unit electrical connector, a power management unit mechanical connector, a power management unit user input switch, a gang box electrical connector, and a gang box mechanical connector.

In an exemplary embodiment, the smart device electrical connector and the power management unit electrical connector are configured to provide for electrical contact of the smart device and the power management unit, the smart device mechanical connector and the power management unit mechanical connector are configured to provide for mechanical coupling of the smart device and the power management unit, the gang box electrical connector is configured to provide for electrical contact of the power management unit and a gang box, the gang box mechanical connector is configured to provide for mechanical coupling of the power management unit and the gang box, and the smart device anti-vibration element is configured to provide for mechanical coupling of the smart device enclosure to a surface and for reducing mechanical vibrations of the smart device caused by sound vibrations emitted from the at least one speaker.

In an exemplary embodiment, the amplifier module of the smart device includes a digital signal processor, a digital to analog converter, and at least one amplifier. The amplifier module is configured for receiving and processing digital data and outputting analog data for producing high fidelity audio.

In an exemplary embodiment, the microcontroller unit module of the smart device includes at least one processor, a non-transitory computer readable medium, and at least one wireless interface. The non-transitory computer-readable medium is configured for storing a computer program comprising instructions which, when executed on the at least one processor, cause the at least one processor to carry out wireless communications and control.

In an exemplary embodiment, the power management module of the power management unit includes a transformer, and a switching component.

In an exemplary embodiment, the user input component of the smart device may be configured to cause the smart device to control lighting from an electrical junction box communicatively coupled to the smart device, adjust a volume of the at least one speaker, and initiate recording of audio input via the at least one microphone.

In an exemplary embodiment, the user input component of the smart device may be a touch screen, a video screen, a tactile interface, a touch slider, a dimmable switch, a panel display, and any combination of the foregoing.

In an exemplary embodiment, the smart device may include one or more wireless interfaces, such as a wireless communication device, a mesh network card, a radio, an antenna, a wireless repeater, a wireless extender, and any combination of the foregoing. The one or more wireless interfaces may be configured for wireless communication using WiFi, Bluetooth, radio waves, z-wave, Ethernet, ZigBee, and any combination of the foregoing.

In an exemplary embodiment, the smart device mechanical connector of the smart device and the power management mechanical connector of the power management unit may be connected using a docking cradle, a magnet connector, a magnet array, a pivot latch, a clip mechanism, a hinge mechanism, hook-shaped clips, screw fasteners, and any combination of the foregoing.

In another exemplary embodiment, the smart device may include a rechargeable battery to provide for operation and use of the smart device when not connected to the power management unit.

The present disclosure further provides a method for providing high fidelity audio and wireless communications and control using a smart device that includes an amplifier module configured for processing digital and analog data for producing high fidelity audio, a microcontroller unit module configured for wireless communications and control, at least one speaker communicatively coupled to the amplifier module, and at least one microphone communicatively coupled to the microcontroller unit, and further using a power management unit that includes a power management module configured for supplying power to the smart device.

In an exemplary embodiment, the method comprises receiving, through the at least one microphone, a first user input, processing, using the microcontroller unit module, the received first user input, based on the processed first user input, transmitting, using the microcontroller unit module, a first request, receiving, using the microcontroller unit module, a first response in response to the transmitted request, processing, using the microcontroller unit module, the received first response, and based on the processed first response, sending, using the microcontroller unit module, a first control signal to the amplifier module.

In an exemplary embodiment, the first user input may be audio input, a voice activation wake word, a voice command, one or more user-spoken key words, and any combination of the foregoing.

In an exemplary embodiment, the first control signal may cause playing audio content, adjusting volume control, playing visual content, turning one or more lights on or off, adjusting one or more thermostats, invoking a smart assistant, and any combination of the foregoing.

In an exemplary embodiment, the smart device further includes a smart device user input component and the power management unit further includes a power management unit user input switch, and the method further includes receiving, through the smart device user input component, a second user input, processing, using the microcontroller unit module, the received second user input, based on the processed second user input, transmitting, using the microcontroller unit module, a second request, receiving, using the power management unit, the second request, and in response to the second request, controlling lighting in electrical contact with the power management unit.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The accompanying drawings exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1A is a partial cutaway view of an environment having exemplary smart device systems in accordance with aspects of the present disclosure.

FIG. 1B is a schematic diagram of the exemplary smart device systems of FIG. 1A and exemplary wireless devices and networks.

FIG. 2A is a functional block diagram of an exemplary smart device system in accordance with aspects of the present disclosure.

FIG. 2B is an exploded view showing components of an exemplary smart device system in accordance with aspects of the present disclosure.

FIG. 2C is an exploded view showing components of an exemplary smart device system in accordance with aspects of the present disclosure.

FIG. 2D is an exploded view showing components of an exemplary smart device system in accordance with aspects of the present disclosure.

FIG. 3A is an isometric view of an exemplary smart device in accordance with aspects of the present disclosure.

FIG. 3B is a front side view of an exemplary smart device in accordance with aspects of the present disclosure.

FIG. 3C is a left side view of an exemplary smart device in accordance with aspects of the present disclosure.

FIG. 3D is a bottom side view of an exemplary smart device in accordance with aspects of the present disclosure.

FIG. 4 is a flow diagram of exemplary communication pathways between the components of an exemplary smart device system in accordance with aspects of the present disclosure.

FIG. 5A is a flow diagram of exemplary device actions in response to user input implemented by an exemplary smart device system in accordance with aspects of the present disclosure.

FIG. 5B is a flow diagram of exemplary device actions in response to user input implemented by an exemplary smart device system in accordance with aspects of the present disclosure.

FIG. 5C is a flow diagram of exemplary device actions in response to user input implemented by an exemplary smart device system in accordance with aspects of the present disclosure.

FIG. 5D is a flow diagram of exemplary device actions in response to user input implemented by an exemplary smart device system in accordance with aspects of the present disclosure.

FIG. 6A is a schematic diagram of an amplifier module of an exemplary smart device in accordance with aspects of the present disclosure.

FIG. 6B is a functional block diagram of an amplifier module of an exemplary smart device in accordance with aspects of the present disclosure.

FIG. 6C is a flow diagram of exemplary functions performed by an amplifier module of an exemplary smart device in accordance with aspects of the present disclosure.

FIG. 7A is a schematic diagram of a microcontroller unit module of an exemplary smart device in accordance with aspects of the present disclosure.

FIG. 7B is a functional block diagram of a microcontroller unit module of an exemplary smart device in accordance with aspects of the present disclosure.

FIG. 7C is a flow diagram of exemplary functions performed by a microcontroller unit module of an exemplary smart device in accordance with aspects of the present disclosure.

FIG. 8A is an isometric diagram of an exemplary power management unit in accordance with aspects of the present disclosure.

FIG. 8B is a front side view of an exemplary power management unit in accordance with aspects of the present disclosure.

FIG. 8C is a left side view of an exemplary power management unit in accordance with aspects of the present disclosure.

FIG. 8D is a bottom side view of an exemplary power management unit in accordance with aspects of the present disclosure.

FIG. 9 is an exploded view showing components of an exemplary power management unit in accordance with aspects of the present disclosure.

FIG. 10A is a schematic diagram of a power management module of an exemplary power management unit in accordance with aspects of the present disclosure.

FIG. 10B is a functional block diagram of a power management module of an exemplary power management unit in accordance with aspects of the present disclosure.

FIG. 10C is a flow diagram of exemplary functions performed by a power management module of an exemplary power management unit in accordance with aspects of the present disclosure.

FIG. 11A is a perspective exploded view of an exemplary configuration of an enclosure for an exemplary smart device in accordance with aspects of the present disclosure.

FIG. 11B is a front side view of an exemplary configuration of an enclosure for an exemplary smart device in accordance with aspects of the present disclosure.

FIG. 11C is a left side exploded view of an exemplary configuration of an enclosure for an exemplary smart device in accordance with aspects of the present disclosure.

FIG. 11D is a bottom side exploded view of an exemplary configuration of an enclosure for an exemplary smart device in accordance with aspects of the present disclosure.

FIG. 12A is a perspective exploded view of an exemplary configuration for an enclosure of an exemplary power management unit in accordance with aspects of the present disclosure.

FIG. 12B is a perspective exploded view of another exemplary configuration for an enclosure of an exemplary power management unit in accordance with aspects of the present disclosure.

FIG. 12C is a left side exploded view of an exemplary configuration for an enclosure of an exemplary power management unit in accordance with aspects of the present disclosure.

FIG. 12D is a front side view of an exemplary configuration for an enclosure of an exemplary power management unit in accordance with aspects of the present disclosure

FIG. 13A is a perspective view of an exemplary power management unit and a smart device in an unengaged position in accordance with aspects of the present disclosure.

FIG. 13B is a perspective view of an exemplary power management unit and a smart device in an engaged position in accordance with aspects of the present disclosure.

FIG. 13C is a perspective view of an exemplary power management unit and a smart device in an unengaged position in accordance with aspects of the present disclosure.

FIG. 14A is a flow diagram of an example method for processing of user input using an exemplary smart device system in accordance with aspects of the present disclosure.

FIG. 14B is a flow diagram of an example method for controlling one or more wired and/or wireless devices and networks using an exemplary smart device system in accordance with aspects of the present disclosure.

FIG. 14C is a flow diagram of an example method for controlling one or more wired and/or wireless devices and networks using an exemplary smart device system in accordance with aspects of the present disclosure.

FIG. 14D is a flow diagram of an example method for processing of user input using an exemplary smart device system in accordance with aspects of the present disclosure.

FIG. 15A is a perspective view illustrating exemplary mechanical connectors for coupling a power management unit and a smart device in accordance with aspects of the present disclosure.

FIG. 15B is a perspective view illustrating exemplary mechanical connectors for coupling a power management unit and a smart device in accordance with aspects of the present disclosure.

FIG. 15C is a perspective view illustrating exemplary mechanical connectors for coupling a power management unit and a smart device in accordance with aspects of the present disclosure.

FIG. 15D is a perspective view illustrating exemplary mechanical connectors for coupling a power management unit and a smart device in accordance with aspects of the present disclosure

FIG. 15E is a perspective view illustrating exemplary mechanical connectors for coupling a power management unit and a smart device in accordance with aspects of the present disclosure

FIG. 15F is a perspective view illustrating exemplary mechanical connectors for coupling a power management unit and a smart device in accordance with aspects of the present disclosure

FIG. 16 is a perspective view of exemplary smart device speaker configurations for one gang (1-gang), two gang (2-gang), three gang (3-gang), and four gang (4-gang) switch gang box configurations in accordance with aspects of the present disclosure.

FIG. 17 is functional block diagram of exemplary audio processing and wake word engine functionality of an exemplary smart device system in accordance with aspects of the present disclosure.

### DETAILED DESCRIPTION

The present invention is described with reference to the attached figures, where like reference numerals are used throughout the figures to designate similar or equivalent elements. The figures are not drawn to scale, and are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

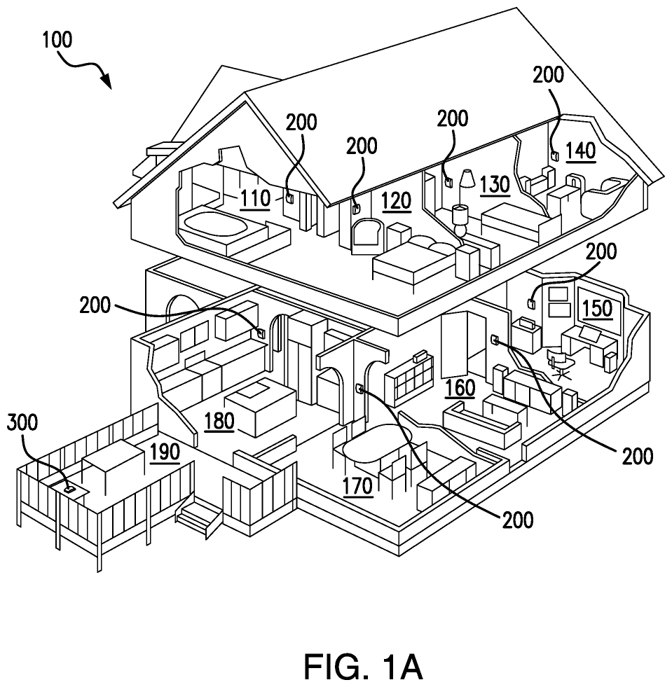

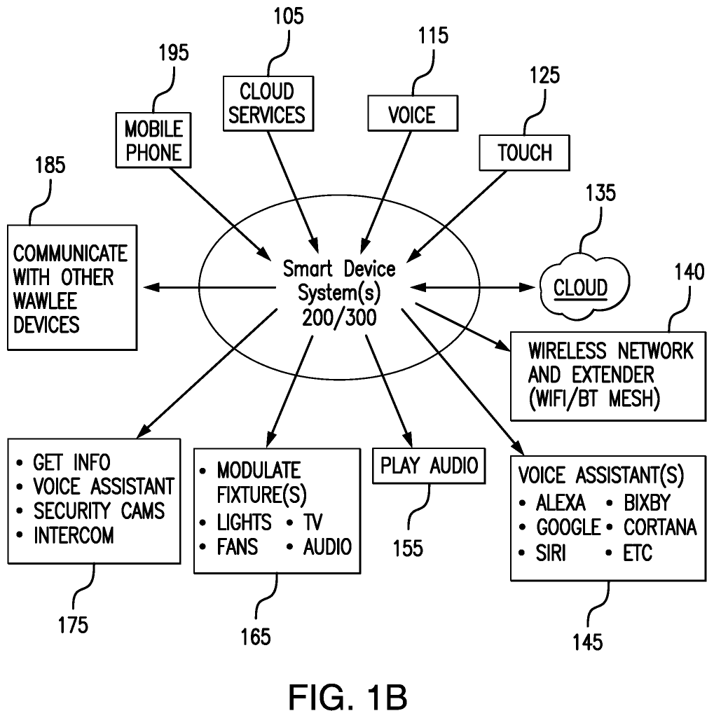

FIG. 1A is a partial cutaway view of an environment 100 having exemplary smart device systems 200, in accordance with aspects of the present disclosure. In this exemplary environment 100, such as a house, the smart device system 200 may be installed in one or more locations in the environment 100, such as, for example, a bathroom 110, bedrooms, 120, 130 and 140, an office 150, a living room 160, a dining room 170, and a kitchen 180.

While, in the exemplary embodiment, the environment 100 is a house, the smart device system 200 of the present disclosure may be installed and is suitable for use in many different environments, such as, for example, an apartment or condominium of a building, an office, a dormitory room, a hotel room, or the like.

Further, in another exemplary embodiment, the smart device 300 of the smart device system 200 may include a rechargeable battery that provides for operation and use of the smart device 300 when not connected to the power management unit of the smart device system 200. With reference to FIG. 1A, the smart device 300 may be used outside on, for example, deck 190. This portable version of the smart device 300 may be operated and used in many different outdoor environments, such as, for example, in a park, at the beach, in a car, on a boat, or the like.

FIG. 1B is a schematic diagram of the exemplary smart device systems 200 and smart devices 300 of FIG. 1A, and exemplary wired and/or wireless devices and networks. Exemplary wired and/or wireless devices and networks that may be used by and communicate with the smart device systems 200 and smart devices 300 of the present disclosure include cloud services 105, voice 115, touch 125, cloud 135, wireless network and extender (WIFI/Bluetooth MESH) 140, voice assistant 145, play audio 155, modulate fixtures 165, get info 175, communicate with other smart device systems 200 and smart devices 300 185, and mobile phones 195. The foregoing indicated wired and/or wireless devices and networks are only examples, and the smart device systems 200 and smart devices 300 of the present disclosure may be used by and communicate with many other types of wired and/or wireless devices and networks.

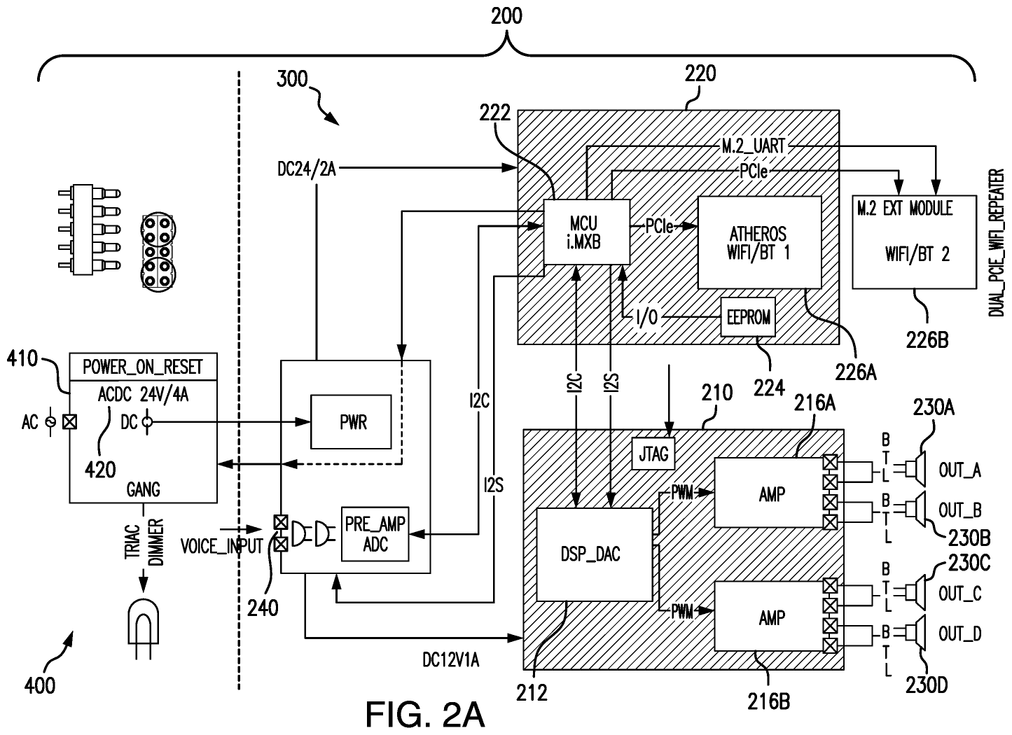

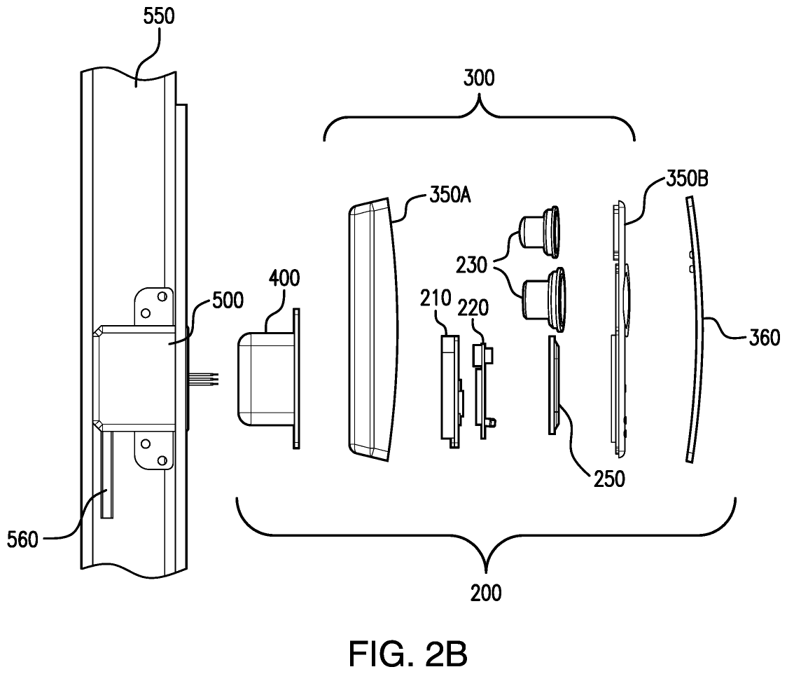

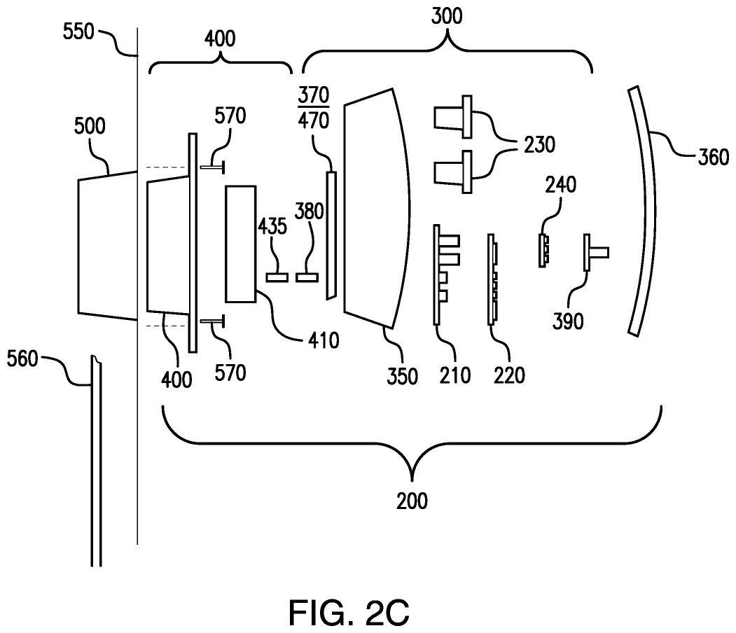

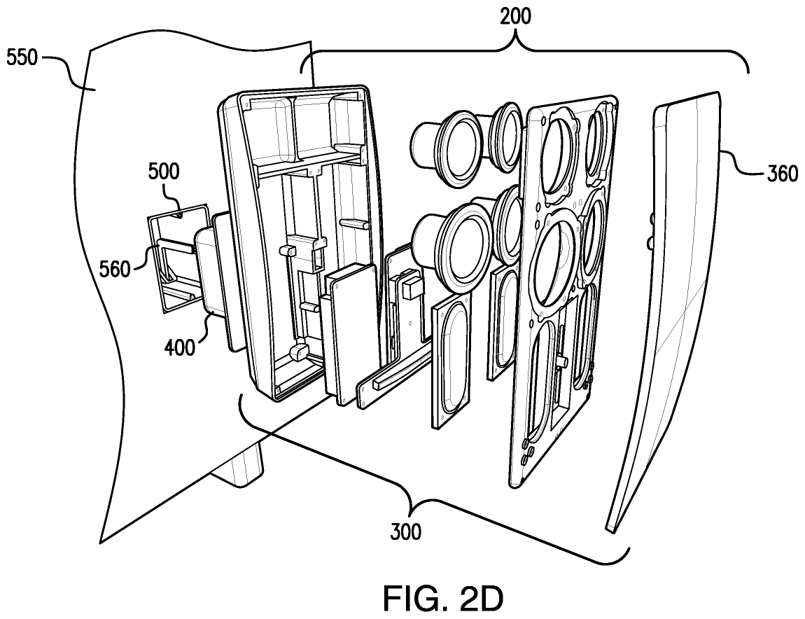

FIG. 2A is a functional block diagram of an exemplary smart device system 200, in accordance with aspects of the present disclosure. More specifically, with reference to FIG. 2A, the modules and components of the smart device system 200, including exemplary communication pathways, according to an exemplary embodiment of the present disclosure, are shown. The smart device system 200 includes a smart device 300 and a power management unit 400.

The smart device system 200 includes an amplifier module 210 configured for processing digital and analog data for producing high fidelity audio, a microcontroller unit module 220 configured for wireless communications and control, one or more speakers 230 communicatively coupled to the amplifier module 210, and one or more microphones 240 communicatively coupled to the microcontroller unit module 220.

In an exemplary embodiment, the amplifier module 210 may include a digital signal processor 212, a digital to analog converter 214, and one or more amplifiers 216. With reference to FIG. 2A, a digital signal processor 212 and a digital to analog converter 214 are shown as a combined DSP_DAC 212/214. A first output (PWM) signal of the combined DSP_DAC 212/214 is transmitted to a first amplifier 216A, and a second output (PWM) signal of the combined DSP_DAC 212/214 is transmitted to a second amplifier 216B. The output from the first and second amplifiers 216A and 216B is transmitted to speakers 230.

Again referring to FIG. 2A, the signal output from first amplifier 216A is transmitted to a first speaker 230A (OUT_A) and a second speaker 230B (OUT_B). The signal output from second amplifier 216B is transmitted to a third speaker 230C (OUT_C) and a fourth speaker 230D (OUT_D).

In an exemplary embodiment, the microcontroller unit module 220 may include one or more processors 222, a non-transitory computer readable medium 224, one or more wireless interfaces 226, and one or more microphones 240. The non-transitory computer readable medium 224 may be configured for storing a computer program comprising instructions which, when executed on the one or more processors 222, cause the one or more processors 222 to carry out wireless communications and control. With reference to FIG. 2A, the one or more processors 222 are shown as, for example, an MCU i.Mx8 212. The non-transitory computer readable medium 224 is shown, for example, as an EEPROM. The one or more wireless interfaces 226 are, for example, ATHEROS WIFI/BT, and in the exemplary embodiment shown, there are two ATHEROS WIFI/BT wireless interfaces, ATHEROS WIFI/BT 1 226A and ATHEROS WIFI/BT 2 226B (M.2 EXT MODULE—DUAL_PCIE_WIFI_REPEATER). The one or more microphones, which may be configured in an array, receive voice input and transmit the received voice input to the one or more processors 222 for processing.

Referring again to FIG. 2A, an exemplary power management unit 400 of smart device system 200 is shown. In an exemplary embodiment, the power management unit 400 includes a power management module 410, which may include a transformer (ACDC 24V/4 A DC) 420.

FIG. 2B is an exploded view showing components of an exemplary smart device system 200, in accordance with aspects of the present disclosure. In an exemplary embodiment, the smart device system 200 is mechanically coupled and electrically connected to a gang box 500, which is installed in a wall 550, and provides a means of supplying electrical current, such as, for example, through a power line 560, to the smart device system 200. More specifically, the power management unit 400 is mechanically coupled and electrically connected to gang box 500. The smart device 300 is mechanically coupled and electrically connected to the power management unit 400. In an exemplary embodiment, the smart device 300, as shown in FIG. 2B, includes a smart device enclosure 350, shown in two parts 350A and 350B, an amplifier module 210, a microcontroller unit module 220, speakers 230, passive radiators 250, and a grille 360.

FIG. 2C is an exploded view showing components of an exemplary smart device system in accordance with aspects of the present disclosure. In an exemplary embodiment, the smart device system 200 is mechanically coupled and electrically connected to a gang box 500, which is installed in a wall 550, and provides a means of supplying electrical current, such as, for example, through a power line 560, to the smart device system 200. More specifically, the power management unit 400 is mechanically coupled to gang box 500 by using, for example, fasteners 570. The power management module 410 of the power management unit 400 may include a transformer 420, such as, for example, an AC-DC transformer dimmable WIFI switch, which is electrically connected to the electrical current supplied by the gang box 500. More specifically, a gang box electrical connector 575 is configured to provide for electrical contact of the power management unit 400 and a gang box 500, and a gang box mechanical connector 580 is configured to provide for mechanical coupling of the power management unit 400 and the gang box 500. The smart device 300 is mechanically coupled and electrically connected to the power management unit 400. More specifically, the smart device 300 includes a smart device mechanical connector 370 configured to provide for mechanical coupling of the smart device 300 and the power management unit 400. The smart device 300 includes a smart device electrical connector 380 and the power management unit 400 includes a power management unit electrical connector 430 configured to provide for electrical contact of the smart device 300 and the power management unit 400. In an exemplary embodiment, the smart device 300, as shown in FIG. 2C, includes a smart device enclosure 350, an amplifier module 210, a microcontroller unit module 220, speakers 230, microphones 240, a smart device user input component 390, such as, for example, as shown in FIG. 2C, a touch slider switch, and a grille 360.

FIG. 2D is an exploded view showing components of an exemplary smart device system 200 in accordance with aspects of the present disclosure. In an exemplary embodiment, the smart device system 200 is mechanically coupled and electrically connected to a gang box 500, which is installed in a wall 550, and provides a means of supplying electrical current, such as, for example, through a power line 560, to the smart device system 200. More specifically, the power management unit 400 is mechanically coupled and electrically connected to a gang box 500. The smart device 300 is mechanically coupled and electrically connected to the power management unit 400. In an exemplary embodiment, the smart device 300, as shown in FIG. 2C, includes a smart device enclosure 350 and a grille 360.

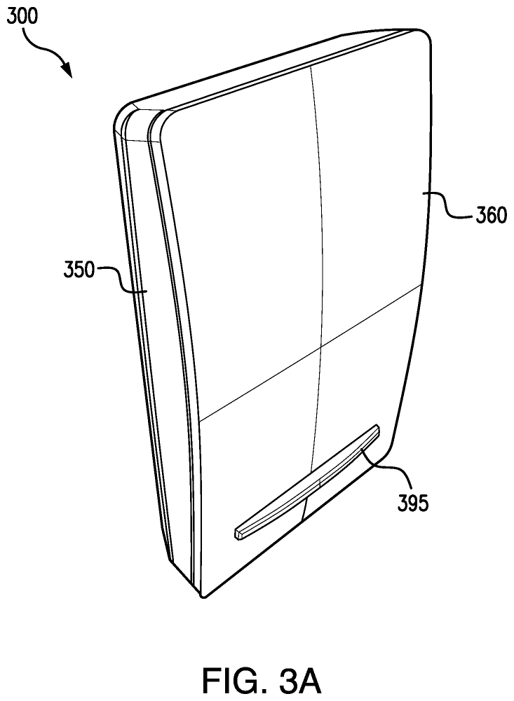

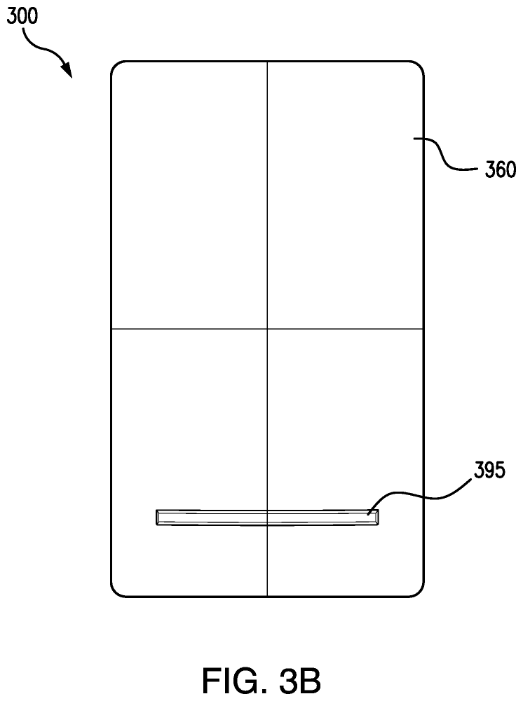

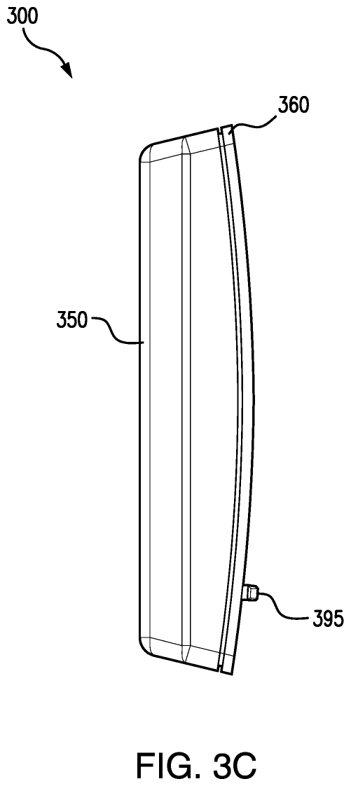

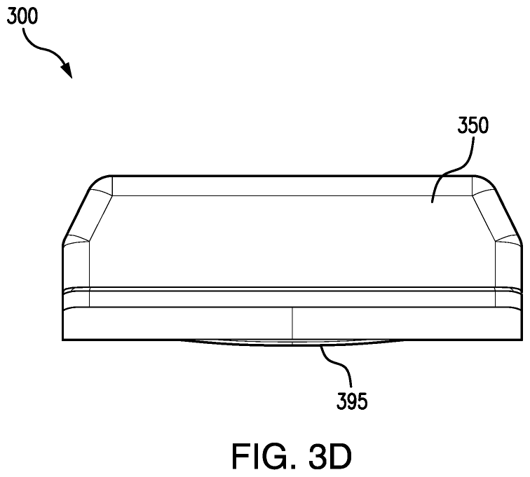

FIG. 3A is an isometric view of an exemplary smart device 300 in accordance with aspects of the present disclosure. The exemplary smart device 300 shown in FIG. 3A illustrates smart device enclosure 350, grille 360, and smart device user input component 395, shown as a touch slider switch. FIG. 3B is a front side view of the exemplary smart device 300 shown in FIG. 3A. FIG. 3C is a left side view of the exemplary smart device 300 shown in FIG. 3A. FIG. 3D is a bottom side view of the exemplary smart device 300 shown in FIG. 3A.

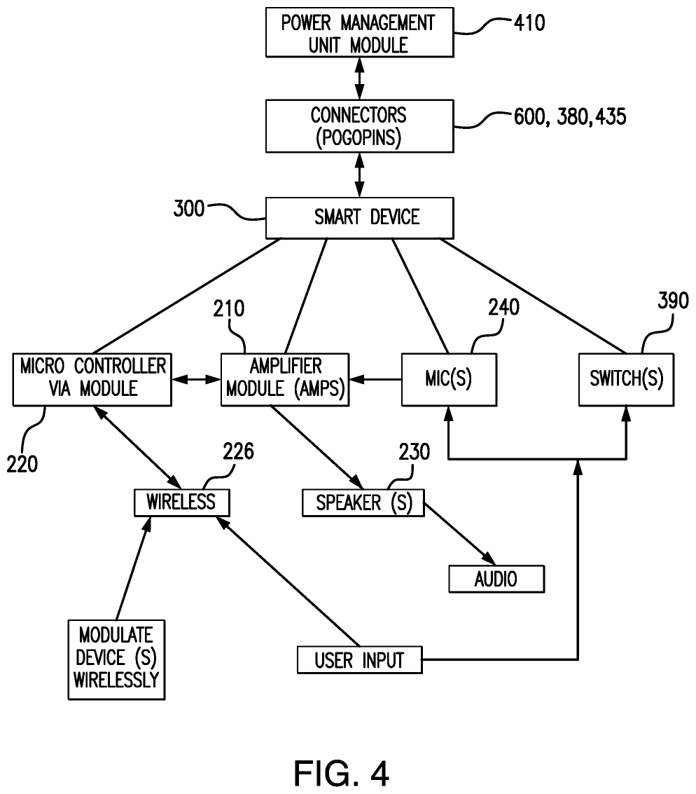

FIG. 4 is a flow diagram of exemplary communication pathways between the components of an exemplary smart device system 200 in accordance with aspects of the present disclosure. As illustrated in FIG. 4, in an exemplary embodiment, the power management module 410 of power management unit 400 communicates with the modules and components of the smart device 300 through connection 600, which may be in the form of pogo pins. Within the smart device 300, the directional arrows show the communication pathways between the amplifier module 210, microcontroller unit module 220, wireless interfaces 226, speakers 230, microphones 240, and smart device user input component (switch) 390.

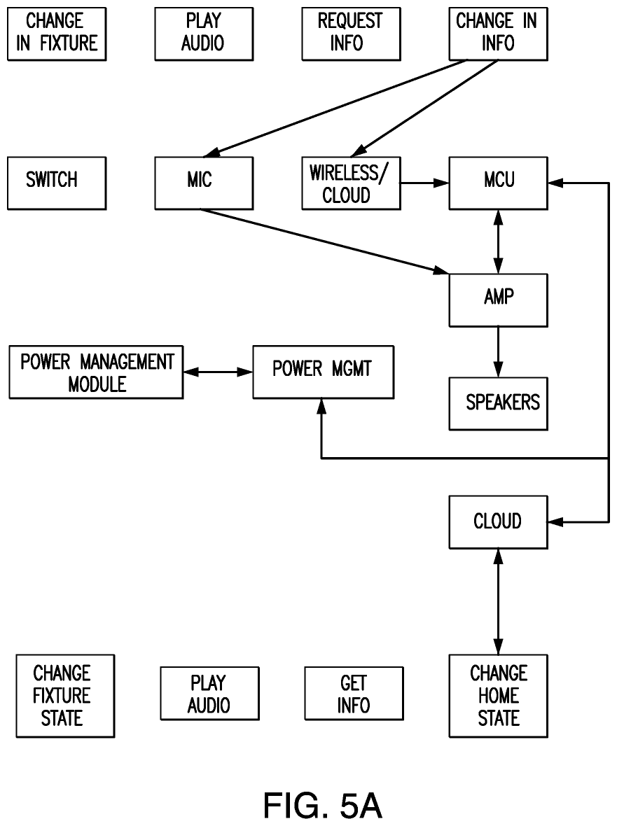

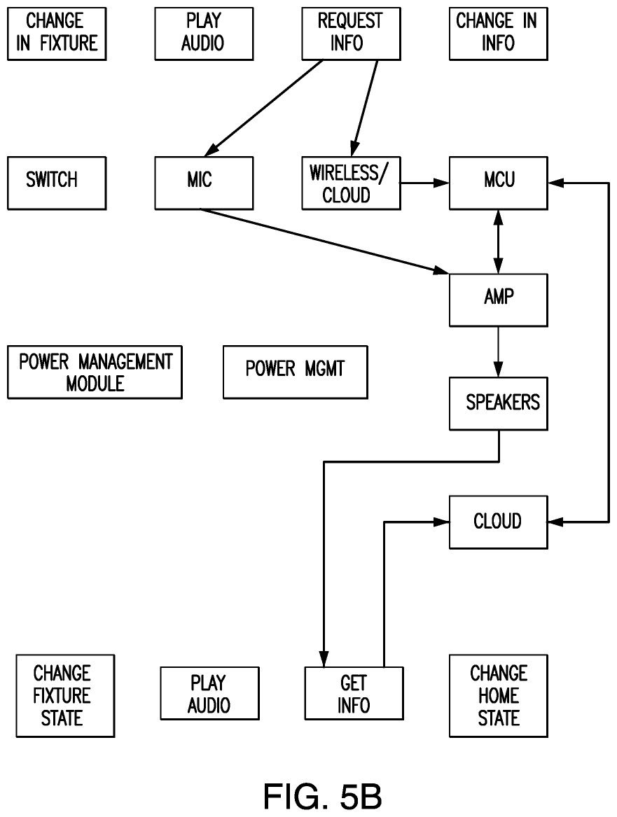

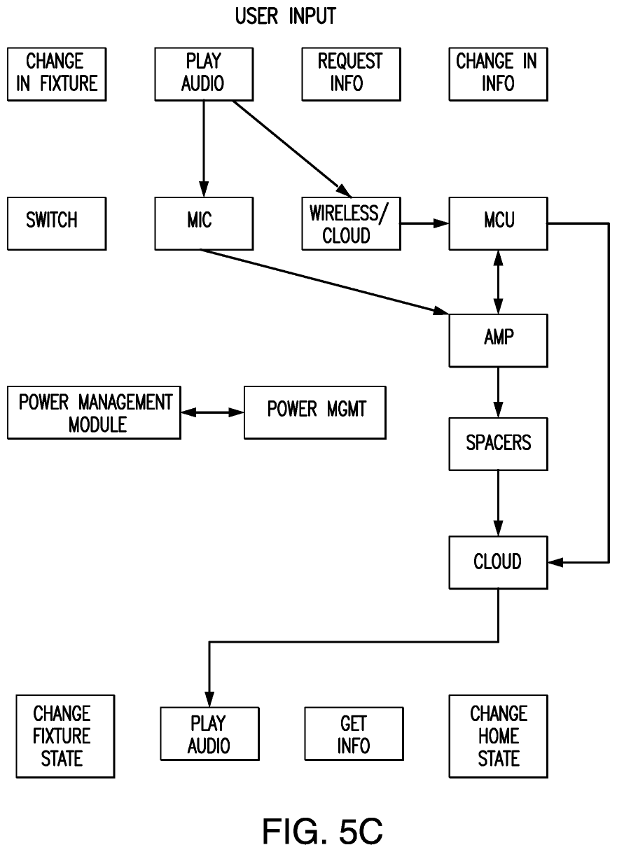

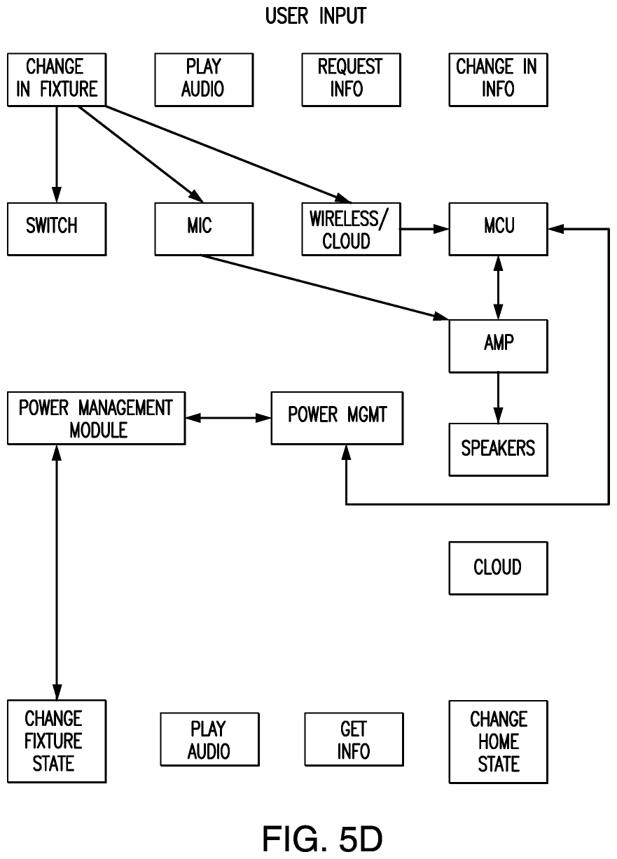

FIG. 5A is a flow diagram of exemplary device actions in response to user input implemented by an exemplary smart device system 200 in accordance with aspects of the present disclosure.

FIG. 5B is a flow diagram of exemplary device actions in response to user input implemented by an exemplary smart device system 200 in accordance with aspects of the present disclosure.

FIG. 5C is a flow diagram of exemplary device actions in response to user input implemented by an exemplary smart device system 200 in accordance with aspects of the present disclosure.

FIG. 5D is a flow diagram of exemplary device actions in response to user input implemented by an exemplary smart device system 200 in accordance with aspects of the present disclosure.

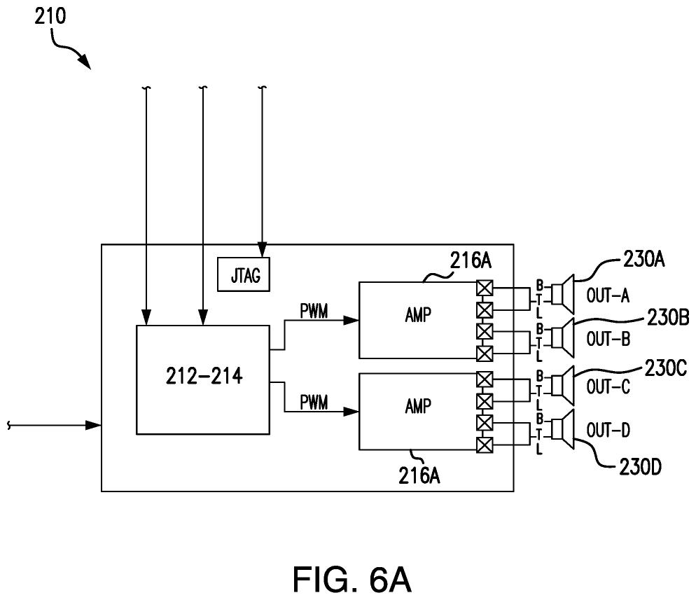

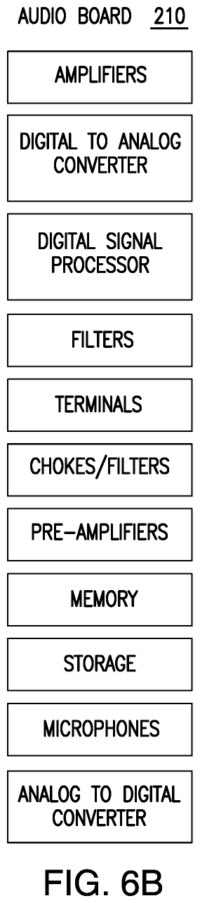

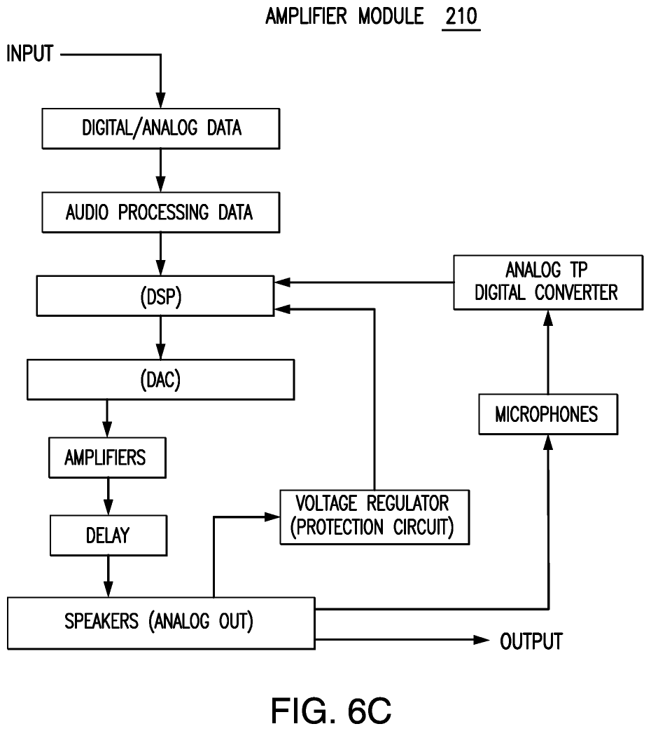

FIG. 6A is a schematic diagram of an amplifier module 210 of an exemplary smart device 300 in accordance with aspects of the present disclosure. In an exemplary embodiment, the amplifier module 210 may include a digital signal processor 212, a digital to analog converter 214, and one or more amplifiers 216. With reference to FIG. 6A, a digital signal processor 212 and a digital to analog converter 214 are shown as a combined DSP_DAC 212/214. A first output (PWM) signal of the combined DSP_DAC 212/214 is transmitted to a first amplifier 216A, and a second output (PWM) signal of the combined DSP_DAC 212/214 is transmitted to a second amplifier 216B. The output from the first and second amplifiers 216A and 216B is transmitted to speakers 230.

Again referring to FIG. 6A, the signal output from first amplifier 216A is transmitted to a first speaker 230A (OUT_A) and a second speaker 230B (OUT_B). The signal output from second amplifier 216B is transmitted to a third speaker 230C (OUT_C) and a fourth speaker 230D (OUT_D).

FIG. 6B is a functional block diagram of an amplifier module 210 of an exemplary smart device 300 in accordance with aspects of the present disclosure.

FIG. 6C is a flow diagram of exemplary functions performed by an amplifier module 210 of an exemplary smart device 300 in accordance with aspects of the present disclosure.

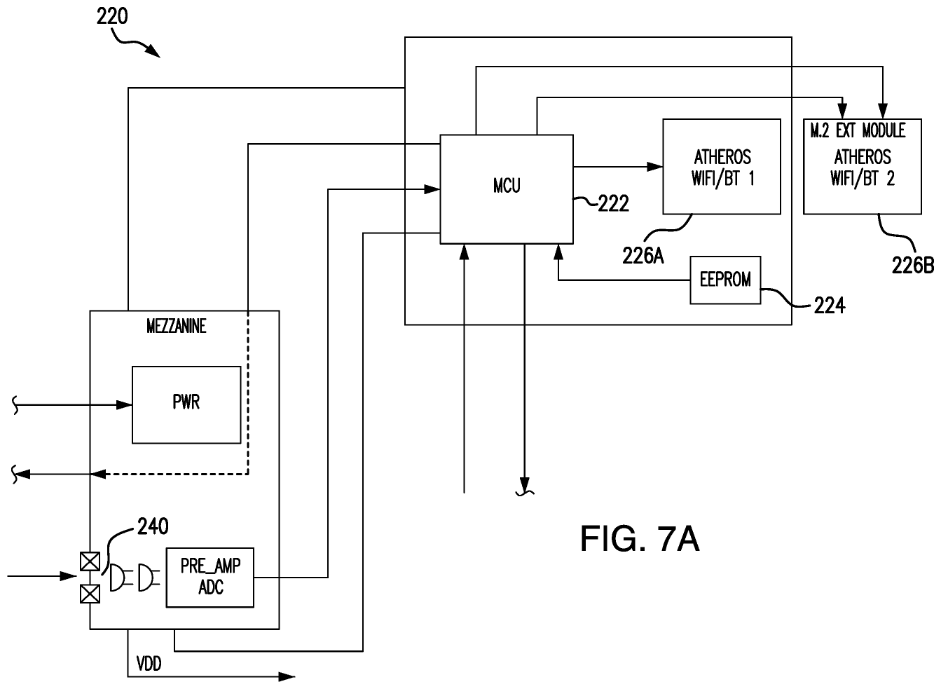

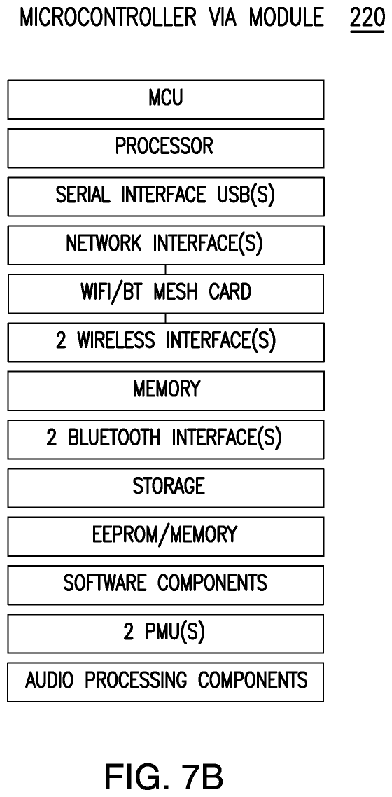

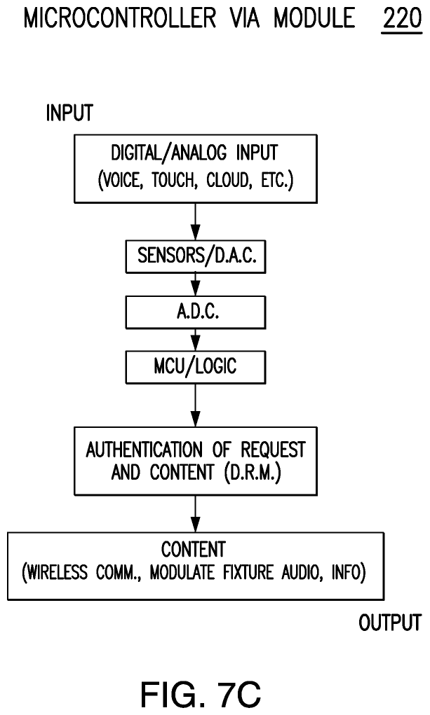

FIG. 7A is a schematic diagram of a microcontroller unit module 220 of an exemplary smart device 300 in accordance with aspects of the present disclosure. In an exemplary embodiment, the microcontroller unit module 220 may include one or more processors 222, a non-transitory computer readable medium 224, one or more wireless interfaces 226, and one or more wireless interfaces 226, and one or more microphones 240. The non-transitory computer readable medium 224 may be configured for storing a computer program comprising instructions which, when executed on the one or more processors 222, cause the one or more processors 222 to carry out wireless communications and control. With reference to FIG. 7A, the one or more processors 222 are shown as, for example, an MCU i.Mx8 212. The non-transitory computer readable medium 224 is shown, for example, as an EEPROM. The one or more wireless interfaces 226 are, for example, ATHEROS WIFI/BT, and in the exemplary embodiment shown, there are two ATHEROS WIFI/BT wireless interfaces, ATHEROS WIFI/BT 1 226A and ATHEROS WIFI/BT 2 226B (M.2 EXT MODULE—DUAL_PCIE_WIFI_REPEATER). The one or more microphones, which may be configured in an array, receive voice input and transmit the received voice input to the one or more processors 222 for processing.

FIG. 7B is a functional block diagram of a microcontroller unit module 220 of an exemplary smart device 300 in accordance with aspects of the present disclosure.

FIG. 7C is a flow diagram of exemplary functions performed by a microcontroller unit module 220 of an exemplary smart device 300 in accordance with aspects of the present disclosure.

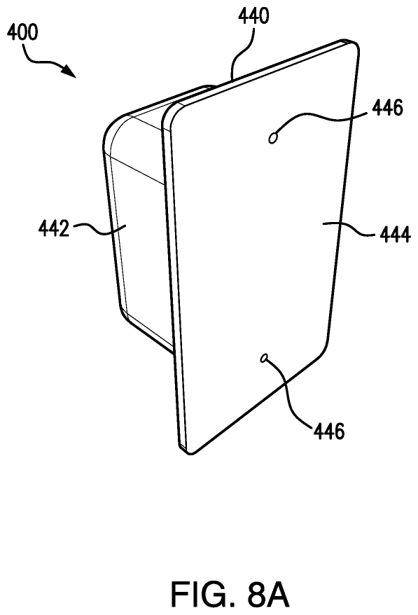

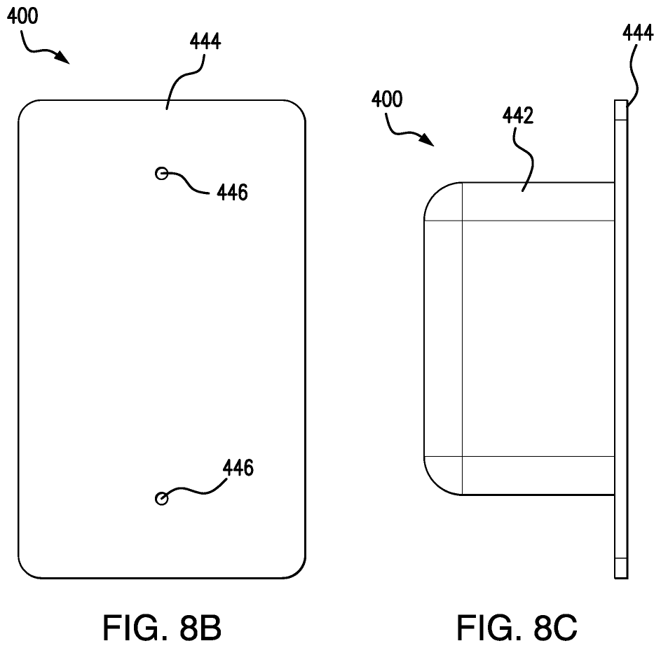

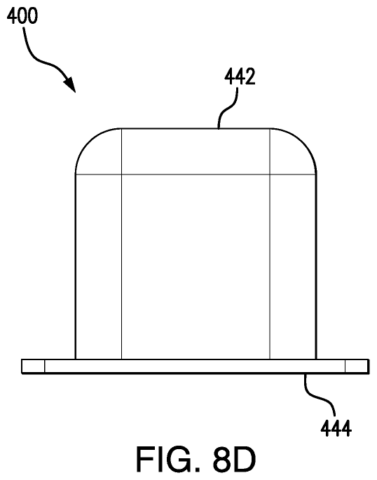

FIG. 8A is an isometric diagram of an exemplary power management unit 400 in accordance with aspects of the present disclosure. The exemplary power management unit 400 shown in FIG. 8A illustrates power management unit enclosure 440, including a gang box insertion portion 442 and a gang box cover portion 444. The gang box cover portion 444 includes openings 446 for fasteners 570 for mechanically coupling the power management unit 400 to the gang box 500. FIG. 8B is a front side view of an exemplary power management unit 400 in accordance with aspects of the present disclosure. FIG. 8C is a left side view of an exemplary power management unit 400 in accordance with aspects of the present disclosure. FIG. 8D is a bottom side view of an exemplary power management unit 400 in accordance with aspects of the present disclosure.

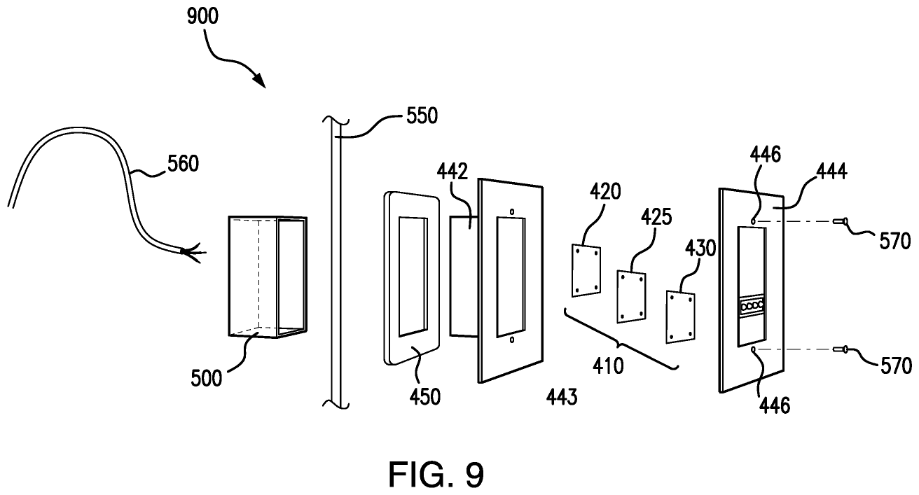

FIG. 9 is an exploded view showing components of an exemplary power management unit 400 in accordance with aspects of the present disclosure. In an exemplary embodiment, the power management unit 400 is mechanically coupled and electrically connected to a gang box 500, which is installed in a wall 550, and provides a means of supplying electrical current, such as, for example, through a power line 560, to the smart device system 200. More specifically, in an exemplary embodiment, the power management unit 400, as shown in FIG. 9, includes a power management unit enclosure 440, which is comprised of two parts, a gang box insertion portion 442 and a gang box cover portion 444. The power management unit 400 also includes a power management module 410, which may be comprised of a transformer 420, a wireless interface 425, and a switching component 430. The gang box insertion portion 442 and gang box cover portion 444 may include openings 446 for fasteners 570, such as, for example, screws, to mechanically couple the power management unit to the gang box 500.

In an exemplary embodiment, a smart device anti-vibration element 450 is included, shown in FIG. 9 as, for example, a wall gasket. The smart device anti-vibration element 450 may be disposed around the gang box insertion portion 442 between the flange 443 and wall 550. The smart device anti-vibration element 450 may be composed of, for example, a compressible dampening/absorbing foam/butyl rubber compound, such as sorbothane and/or soft silicone.

In an exemplary embodiment, the gang box cover portion 444 may also be configured to receive a power management unit electrical connector 435, such as, for example, pogo pins, as shown in FIG. 9. In an exemplary embodiment, one of the pins is longer and contacts first to prevent electrocution. In another exemplary embodiment, one of the pins is a conductive rectangle around the remaining pins, that contacts first for safety purposes. The pogo pins may first contact the pcb in an “unengaged” state, and then, as the smart device 300 is slid into its engaged state, the pogo pins slide along the pcb into their “engaged” state. The contact patch on the pcb is designed in such a way where the position of the pogo pins is known for sake of safety/electrocution.

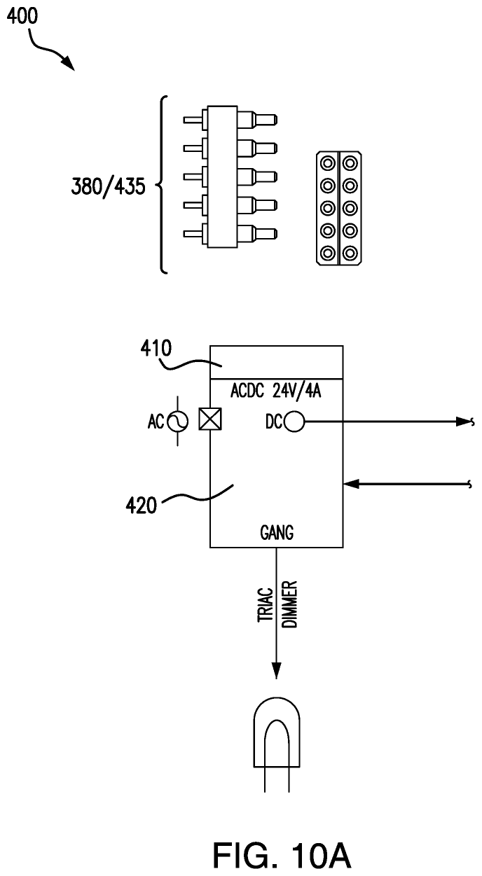

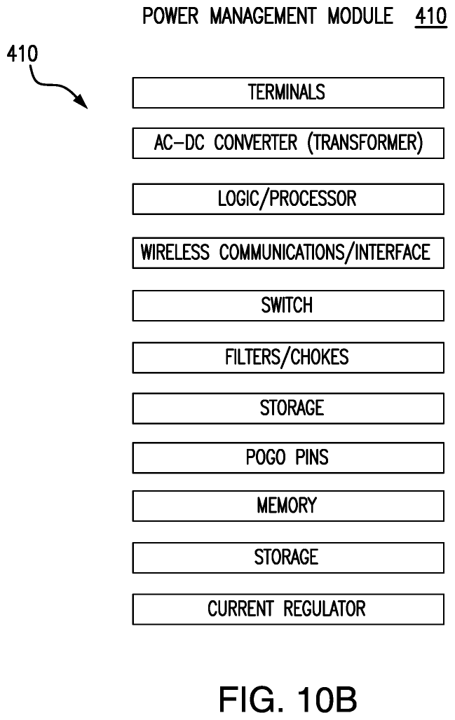

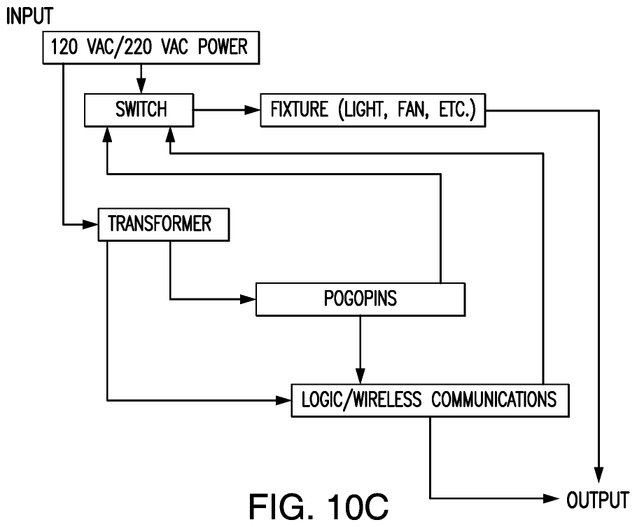

FIG. 10A is a schematic diagram of a power management module of an exemplary power management unit 400 in accordance with aspects of the present disclosure. In an exemplary embodiment, the power management unit 400 includes a power management module 410, which may include a transformer (PWR) 420 and a switching component (PRE AMP ADC) 430.

FIG. 10B is a functional block diagram of a power management module 410 of an exemplary power management unit in accordance with aspects of the present disclosure.

FIG. 10C is a flow diagram of exemplary functions performed by a power management module 410 of an exemplary power management unit in accordance with aspects of the present disclosure.

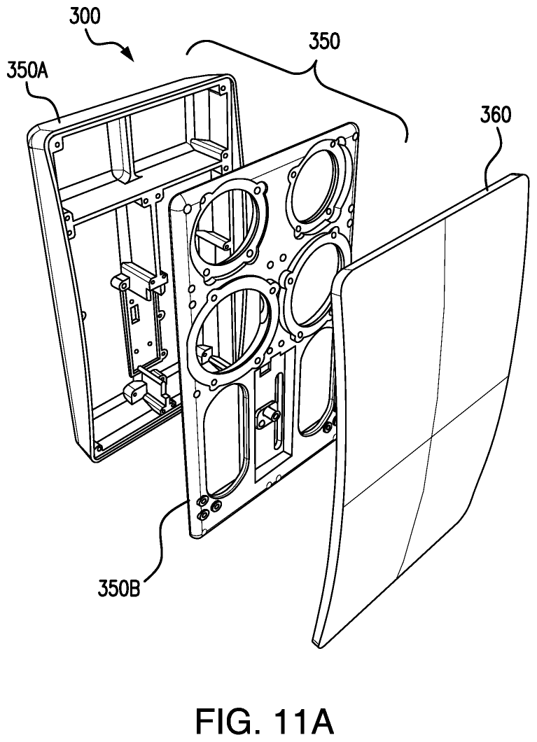

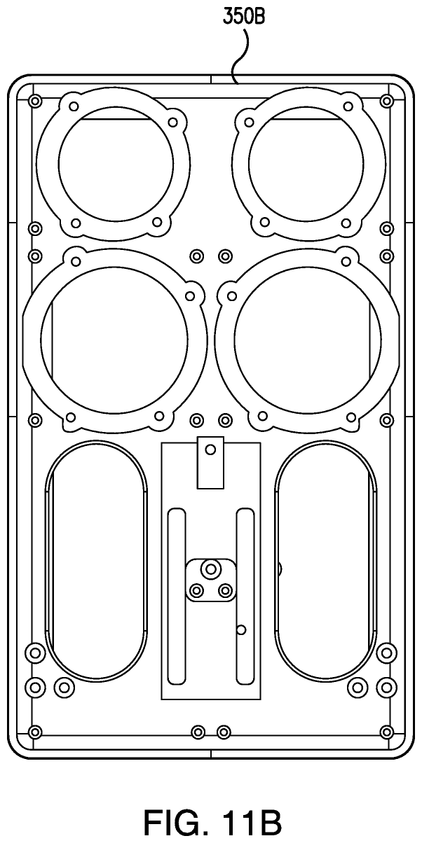

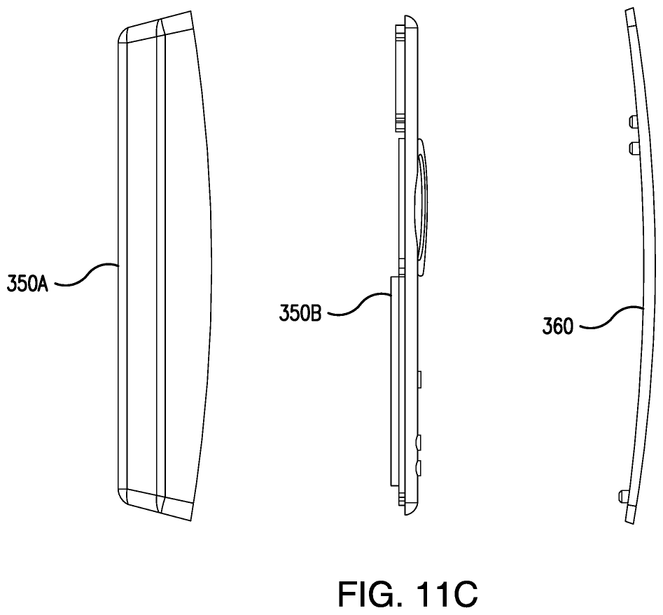

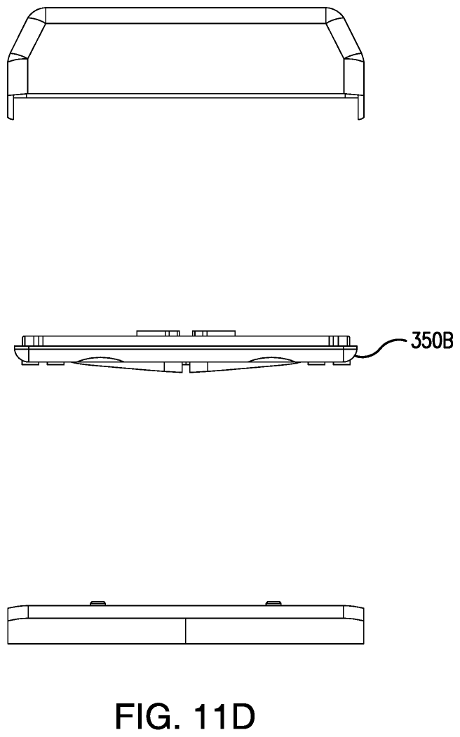

FIG. 11A is a perspective exploded view of an exemplary configuration of an enclosure 350 for an exemplary smart device 300 in accordance with aspects of the present disclosure. In an exemplary embodiment, the smart device enclosure 350 is comprised of two parts 350A and 350B. Enclosure portion 350A is configured to receive and secure the components and modules disposed in the smart device. Enclosure portion 350B is configured to provide openings for speakers 230 and passive radiators 250. While not part of the enclosure 350, a grille 360 is also shown. FIG. 11B is a front side view of an exemplary configuration of an enclosure 350 for an exemplary smart device 300 in accordance with aspects of the present disclosure. FIG. 11C is a left side exploded view of an exemplary configuration of an enclosure 350 for an exemplary smart device 300 in accordance with aspects of the present disclosure. FIG. 11D is a bottom side exploded view of an exemplary configuration of an enclosure 350 for an exemplary smart device 300 in accordance with aspects of the present disclosure.

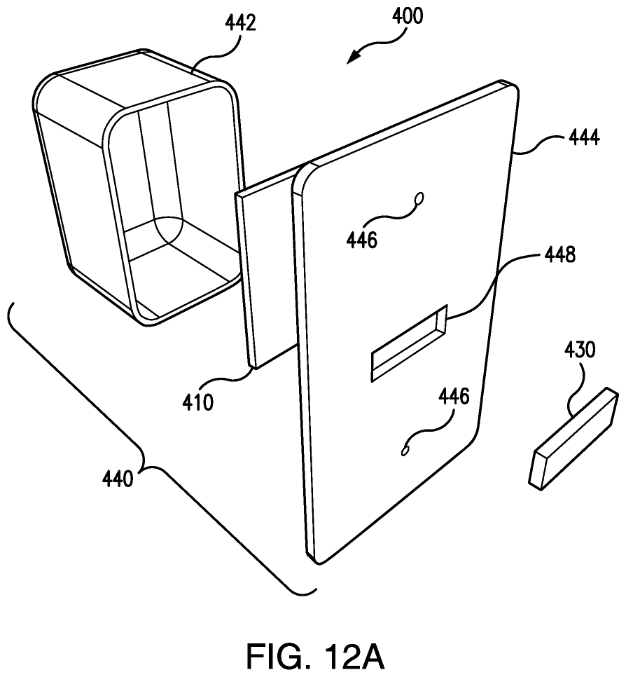

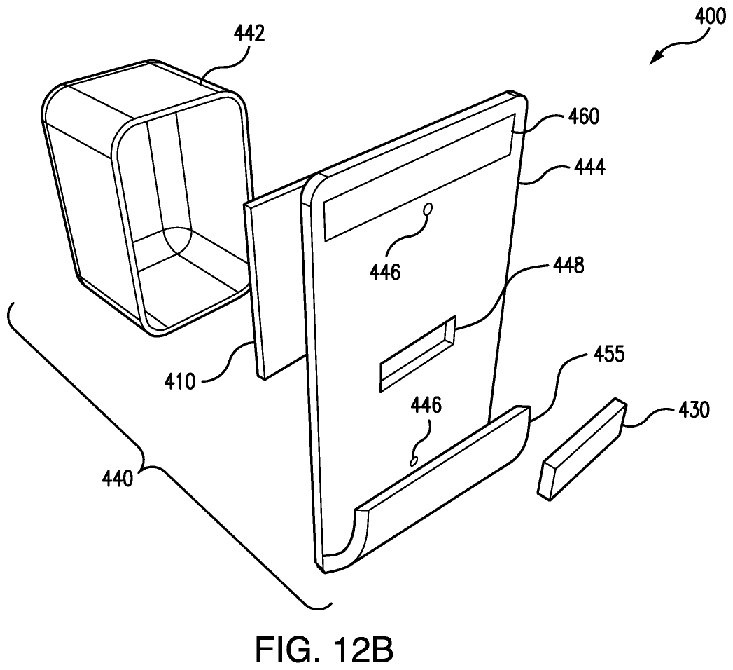

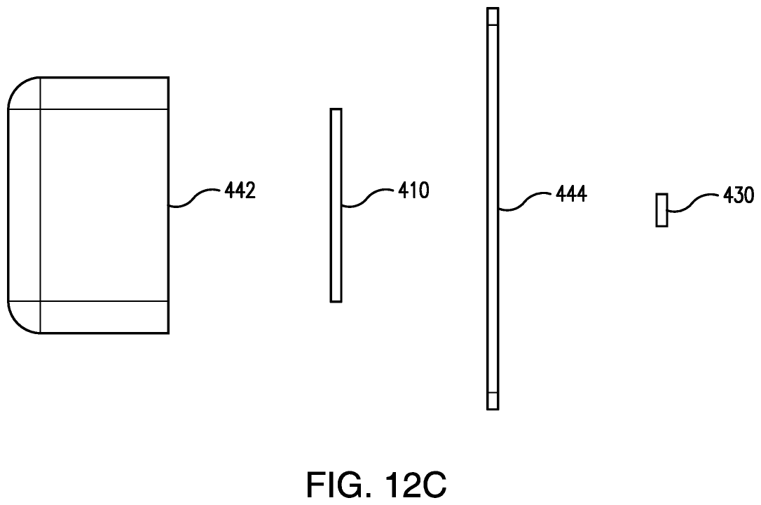

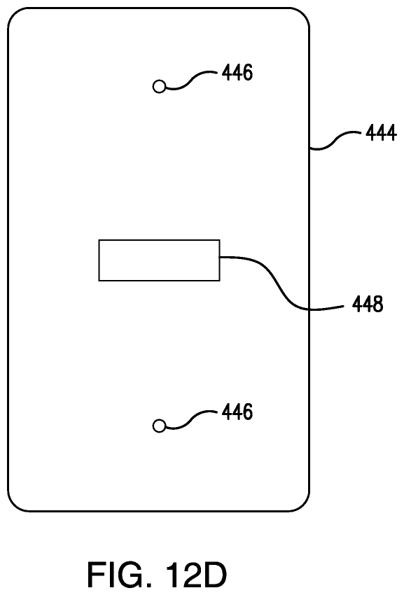

FIG. 12A is a perspective exploded view of an exemplary configuration for an enclosure 440 of an exemplary power management unit 400 in accordance with aspects of the present disclosure. In an exemplary embodiment, the power management unit is comprised of two parts, a gang box insertion portion 442 and a gang box cover portion 444. In addition to openings 446 in the gang box cover portion for fasteners 570 to mechanically couple the power management unit 400 to the gang box 500, there is a switch opening 448 provided for controlling a switching component 430 to turn, for example, a light electrically connected to the power management unit 400, on and off when the smart device 300 is disengaged from the power management unit 400.

FIG. 12B is a perspective exploded view of another exemplary configuration for an enclosure 440 of an exemplary power management unit 400 in accordance with aspects of the present disclosure. In this exemplary embodiment, the gang box cover portion 444 includes, at the bottom of the cover portion 444, a cradle 455 in which the smart device 300 can be docked, and, at the top of the cover portion 444, a magnet 460 for mechanically coupling the smart device 300 to the power management unit 400.

FIG. 12C is a left side exploded view of an exemplary configuration for an enclosure 440 of an exemplary power management unit 400 in accordance with aspects of the present disclosure. FIG. 12D is a front side view of an exemplary configuration for an enclosure 400 of an exemplary power management unit 440 in accordance with aspects of the present disclosure

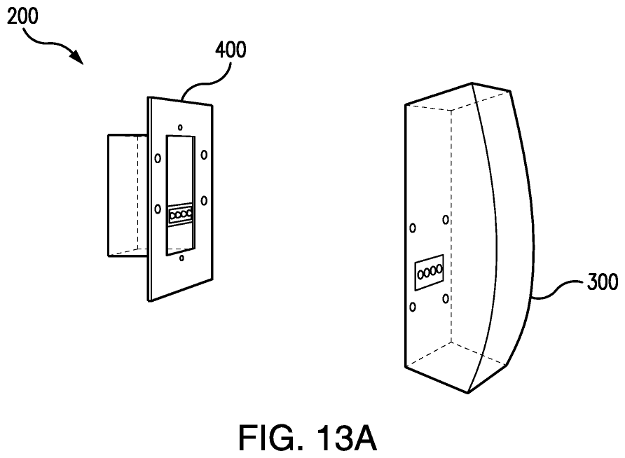

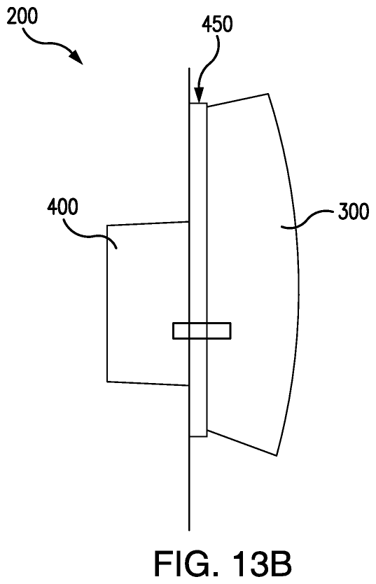

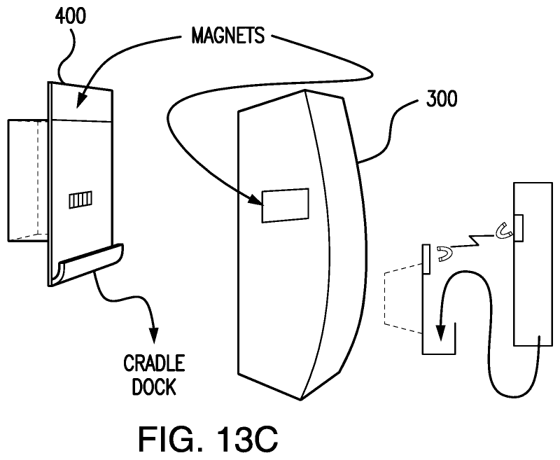

FIG. 13A is a perspective view of an exemplary power management unit 400 and a smart device 300 in an unengaged position in accordance with aspects of the present disclosure.

FIG. 13B is a perspective view of an exemplary power management unit 400 and a smart device 300 in an engaged position in accordance with aspects of the present disclosure.

FIG. 13C is a perspective view of an exemplary power management unit 400 and a smart device 300 in an unengaged position in accordance with aspects of the present disclosure.

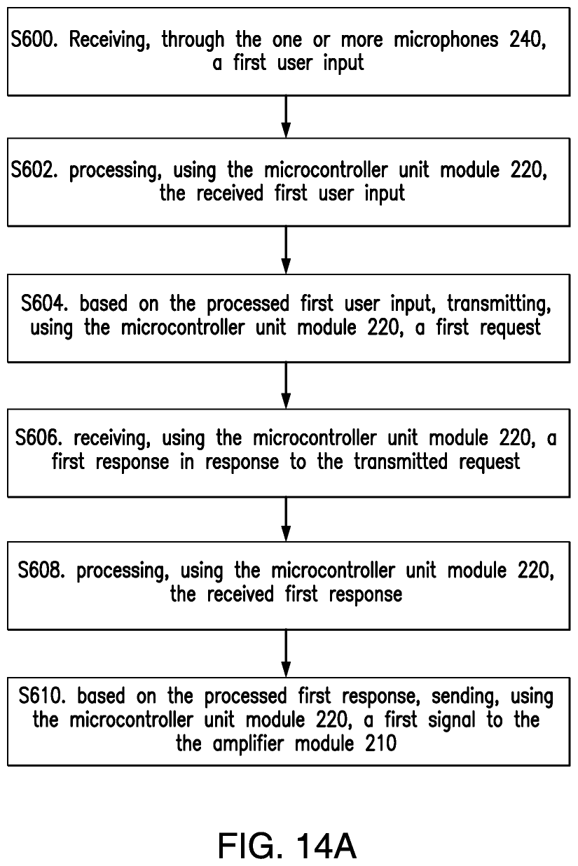

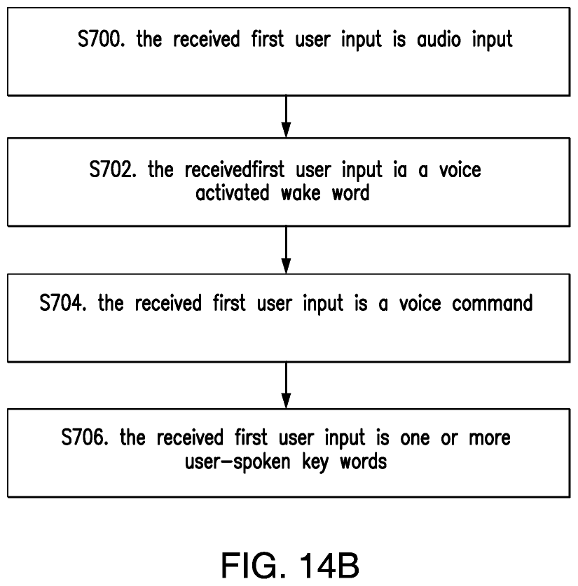

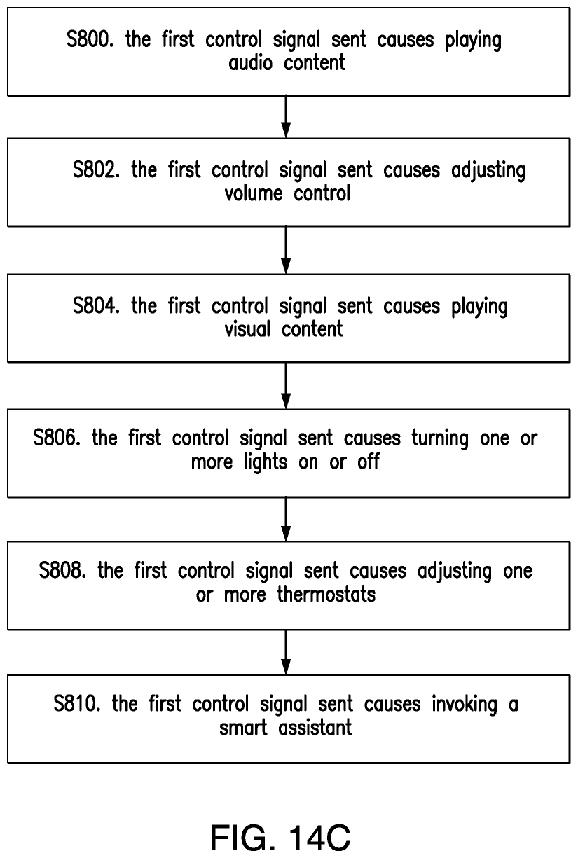

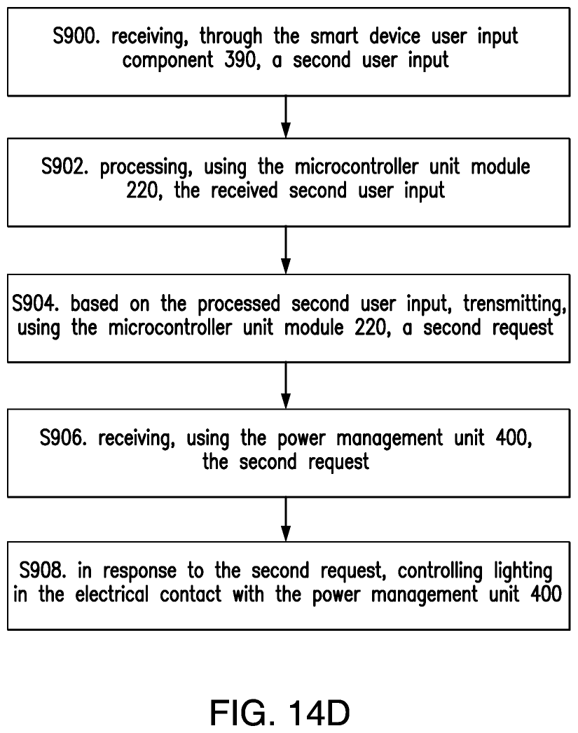

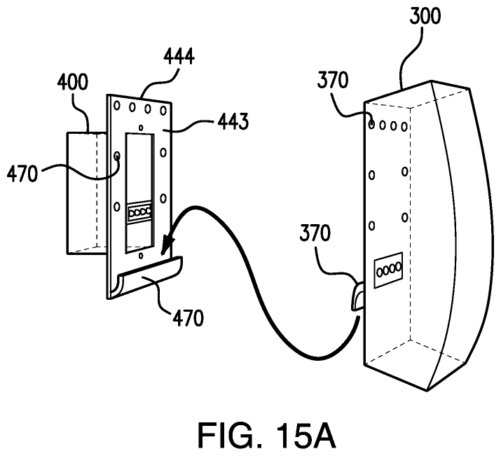

FIG. 14A is a flow diagram of an example method for processing of user input using an exemplary smart device system 200 in accordance with aspects of the present disclosure. In an exemplary embodiment, the method comprises, step S600, receiving, through the one or more microphones 240, a first user input. At step S602, processing, using the microcontroller unit module 220, the received first user input. At step S604, based on the processed first user input, transmitting, using the microcontroller unit module 220, a first request. At step S606, receiving, using the microcontroller unit module 220, a first response in response to the transmitted request. At step S608, processing, using the microcontroller unit module 220, the received first response. At step S610, based on the processed first response, sending, using the microcontroller unit module 220, a first control signal to the amplifier module 210.

FIG. 14B is a flow diagram of an example method for controlling one or more wired and/or wireless devices and networks using an exemplary smart device system in accordance with aspects of the present disclosure. In the example method described with reference to FIG. 14A, at step S600, a first user input is received through the one or more microphones 240. Referring now to FIG. 14B, at step S700, the received first user input is audio input. At step S702, the received first user input is a voice activation wake word. At step S704, the received first user input is a voice command. At step S706, the received first user input is one or more user-spoken key words.

FIG. 14C is a flow diagram of an example method for controlling one or more wired and/or wireless devices and networks using an exemplary smart device system in accordance with aspects of the present disclosure. In the example method described with reference to FIG. 14A, at step S610, based on the processed first response, a first control signal is sent, using the microcontroller unit module 220, to the amplifier module 210.

Referring now to FIG. 14C, at step S800, the first control signal sent causes playing audio content. At step S802, the first control signal sent causes adjusting volume control. At step S804, the first control signal sent causes playing visual content. At step S806, the first control signal sent causes turning one or more lights on or off. At step S808, the first control signal sent causes adjusting one or more thermostats. At step S810, the first control signal sent causes invoking a smart assistant.

FIG. 14D is a flow diagram of an example method for processing of user input using an exemplary smart device system in accordance with aspects of the present disclosure. In an exemplary embodiment, the method described with reference to FIG. 14A further comprises, step S900, receiving, through the smart device user input component 390, a second user input. At step S902, processing, using the microcontroller unit module 220, the received second user input. At step S904, based on the processed second user input, transmitting, using the microcontroller unit module 220, a second request. At step S906, receiving, using the power management unit 400, the second request. At step S908, in response to the second request, controlling lighting in electrical contact with the power management unit 400.

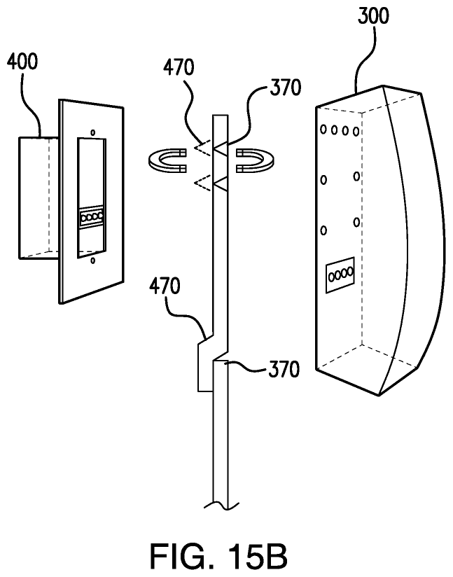

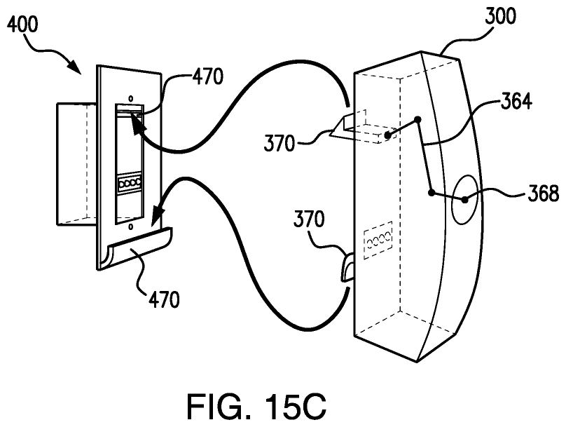

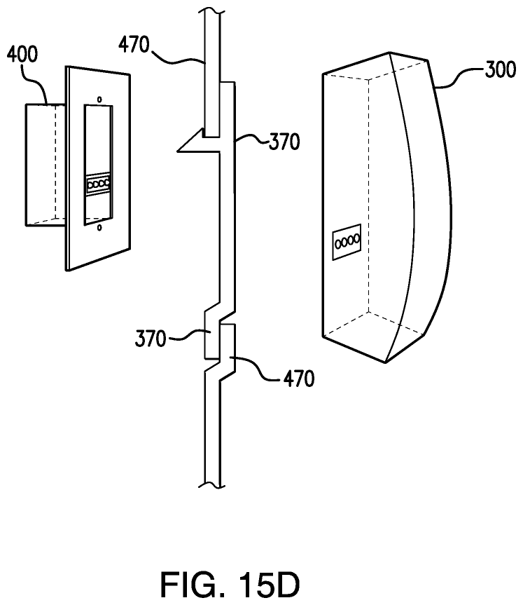

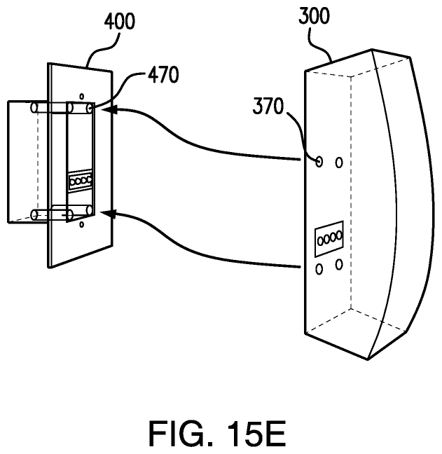

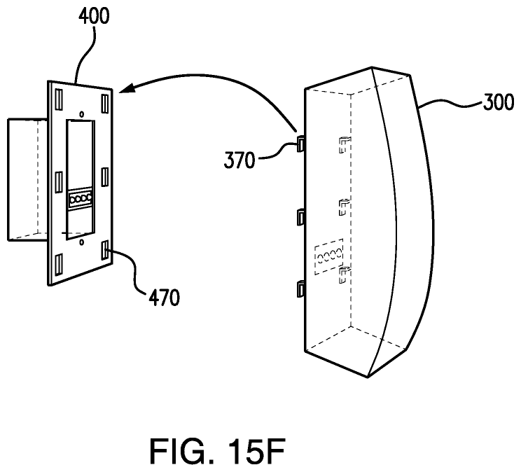

FIG. 15A is a perspective view illustrating exemplary mechanical connectors for coupling a power management unit 400 and a smart device 300 in accordance with aspects of the present disclosure. In an exemplary embodiment, the power management unit 400 and smart device 300 are configured with a pivot latch mechanism and a magnet array for mechanically coupling the smart device 300 to the power management unit 400. More specifically, the smart device mechanical connector 370 includes a male pivot latch disposed on the lower portion on the back side of the smart device 300 and a magnet array also disposed on the back side of the smart device 300 along the top portion and sides. The power management unit mechanical connector 470 includes a female pivot latch disposed at the bottom portion of the flange 443 of the gang box cover portion 444 and a magnet array on the front side of the flange 443 of the gang box cover portion 444 positioned to correspond to the position of the magnets disposed on the back side of the smart device 300.

FIG. 15B is a perspective view illustrating exemplary mechanical connectors 370 and 470 for coupling a power management unit and a smart device in accordance with aspects of the present disclosure. In an exemplary embodiment, the power management unit 400 and smart device 300 are configured with a hinge, pivot seat mechanism and a magnets with alignment detents for mechanically coupling the smart device 300 to the power management unit 400. More specifically, the smart device mechanical connector 370 includes a male hinge pivot disposed on the lower portion on the back side of the smart device 300 and a magnet with alignment detents disposed on the back side of the smart device 300 along the top portion. The power management unit mechanical connector 470 includes a female hinge seat disposed at the bottom portion of the flange 443 of the gang box cover portion 444 and a magnet with alignment detents on the front side of the flange 443 of the gang box cover portion 444 positioned to correspond to the position of the alignment detents disposed on the back side of the smart device 300.

FIG. 15C is a perspective view illustrating exemplary mechanical connectors 370 and 470 for coupling a power management unit and a smart device in accordance with aspects of the present disclosure. In an exemplary embodiment, the power management unit 400 and smart device 300 are configured with a pivot latch mechanism and a clip with a button linkage for mechanically coupling the smart device 300 to the power management unit 400. More specifically, the smart device mechanical connector 370 includes a male pivot latch disposed on the lower portion on the back side of the smart device 300 and an articulating, protruding male clip disposed on the back side of the smart device 300 mechanically coupled to a linkage 364 and button 368 disposed on the front side of the smart device 300. The power management unit mechanical connector 470 includes a female pivot latch disposed at the bottom portion of the flange 443 of the gang box cover portion 444 and a horizontal female opening, adapted to receive the articulating, protruding male clip, disposed at the top of the opening in the gang box cover portion 444, and positioned to correspond to the position of the articulating, protruding male clip on the back side of the smart device 300. In an exemplary embodiment, the button may be spring loaded and disposed under the grill, and actuates a number of clips which are used to secure the smart device 300 to the power management unit 400.

FIG. 15D is a perspective view illustrating exemplary mechanical connectors 370 and 470 for coupling a power management unit and a smart device in accordance with aspects of the present disclosure. In an exemplary embodiment, the power management unit 400 and smart device 300 are configured with a hinge, pivot seat mechanism and a clip for mechanically coupling the smart device 300 to the power management unit 400. More specifically, the smart device mechanical connector 370 includes a male pivot latch disposed on the lower portion on the back side of the smart device 300 and a male protruding clip also disposed on the back side of the smart device 300 along the top portion. The power management unit mechanical connector 470 includes a female pivot latch disposed at the bottom portion of the flange 443 of the gang box cover portion 444 and a female clip receiving opening on the front side of the flange 443 of the gang box cover portion 444 positioned to correspond to the position of the male protruding clip disposed on the back side of the smart device 300. In an exemplary embodiment, the flange 443, the hinge pivot seat mechanism, and the clip may be made from a metal material or the like.

FIG. 15E is a perspective view illustrating exemplary mechanical connectors 370 and 470 for coupling a power management unit and a smart device in accordance with aspects of the present disclosure. In an exemplary embodiment, the power management unit 400 and smart device 300 are configured with simple screw fasteners for mechanically coupling the smart device 300 to the power management unit 400. More specifically, the smart device mechanical connector 370 includes four screw fasteners disposed on the back side of the smart device 300. The power management unit mechanical connector 470 includes four screw fasteners, one disposed at each of the corners of the opening in the gang box cover portion 444 and positioned to correspond to the position of the fasteners disposed on the back side of the smart device 300. More or less screw fasteners can be used depending on the size, shape, and weight of the smart device 300.

FIG. 15F is a perspective view illustrating exemplary mechanical connectors 370 and 470 for coupling a power management unit and a smart device in accordance with aspects of the present disclosure. In an exemplary embodiment, the power management unit 400 and smart device 300 are configured with hook shaped clips for mechanically coupling the smart device 300 to the power management unit 400. More specifically, the smart device mechanical connector 370 includes six hook shaped male protruding clips disposed on the back side of the smart device 300. The power management unit mechanical connector 470 includes six hook receiving shaped female clip receivers, each disposed equidistant at the corners and along the vertical sides of the flange 443 of the gang box cover portion 444, and positioned to correspond to the position of the hook shaped male protruding clips disposed on the back side of the smart device 300. More or less hook shaped clips can be used depending on the size, shape, and weight of the smart device 300.

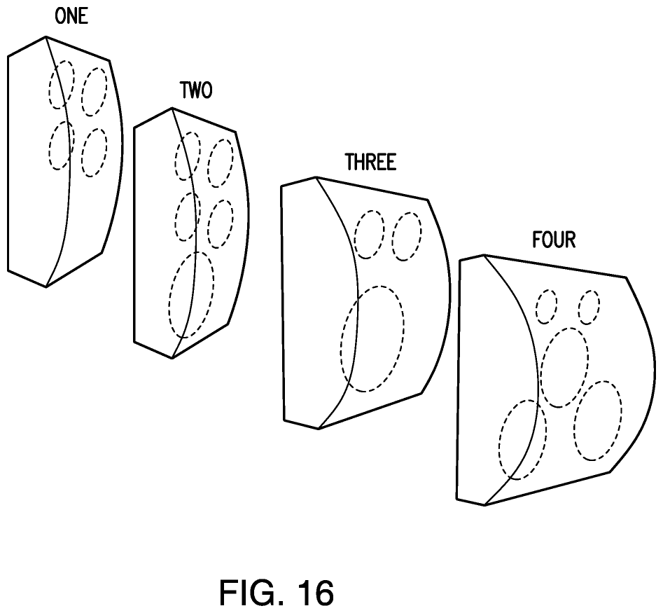

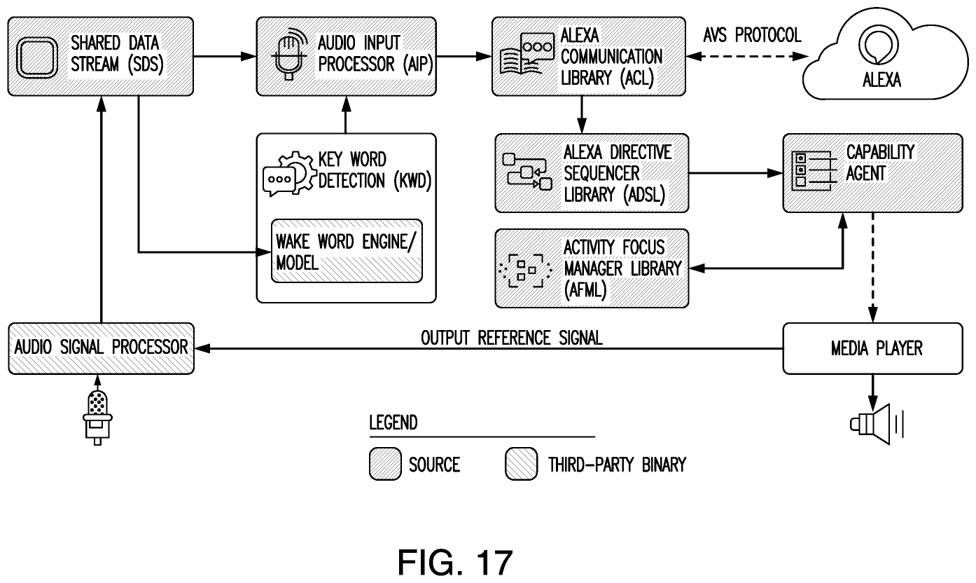

FIG. 16 is a perspective view of exemplary smart device speaker configurations for one gang (1-gang), two gang (2-gang), three gang (3-gang), and four gang (4-gang) switch gang box configurations in accordance with aspects of the present disclosure. The speaker configurations, in terms of the number of speakers, types, sizes, etc., may be changed and optimized based on whether the smart device system 200 will be used with a one gang (1-gang), two gang (2-gang), three gang (3-gang), or four gang (4-gang) switch gang box configuration.

In an exemplary embodiment, one or more speakers 230 may include, for example, one driver unit. In another exemplary embodiment, the driver unit is a tweeter or a woofer. In another exemplary embodiment, two speakers are positioned in line to each other. In another exemplary embodiment, the number of speakers could be increased based on whether the smart device system 200 will be used with a one gang (1-gang), two gang (2-gang), three gang (3-gang), or four gang (4-gang) switch gang box configuration and/or based on the space provided in the smart device 300.

In another exemplary embodiment, the smart device system 200 is configured to include four speakers—two of one type and size, and two of a different type and sizes. The four speakers may be mounted with two passive radiators in an exemplary configuration and shape positioned adjacent to and below them. In other exemplary embodiments, any number of speakers and any number of passive radiators can be used to optimize the sound quality and fidelity.

As described above, in an exemplary embodiment, the smart device 300 is uncoupled from a power management unit 400, and power is provided for the electronic components with a rechargeable battery disposed in the smart device 300. The rechargeable battery provides portability for the smart 300, and the power management unit 400 acts as a charging dock for the smart device 300. When the smart device 300 is docked to the power management module 400, the smart device 300 receives constant power and charges the battery. When the smart device 300 is removed, it can be brought anywhere and does not require a power outlet to provide power for device functionality.

When the one or more wireless interfaces 226 of the microcontroller unit module 220 are connected to Wi-Fi, the smart device 300 can use smart device functionality through a Wi-Fi repeater and/or a smart assistant. When the one or more wireless interfaces 226 of the microcontroller unit module 220 are not connected to Wi-Fi, the smart device 300 can use smart device functionality through a Bluetooth connection and/or radio technology.

The smart device anti-vibration element 450 seals the smart device 300 against a wall 550 to control vibrations/rattling/sound absorption. In some examples, the smart device anti-vibration element 450 selectively eliminates certain frequencies and allows others to resonate to the wall to further adjust the sound signature. The smart device anti-vibration element 450 further assists attachment between the smart device 300 and a gang box 500. For example, the smart device anti-vibration element 450 can be configured to provide for suction, friction, or stickiness between the smart device anti-vibration element 450 and a wall 550 and/or gang box 500. Therefore, the smart device anti-vibration element 450 creates both rigid and fluid connections between the two for the purposes of transferring power and data through an electrical connector, such as Pogo Pins, and eliminating or tuning the vibrations that pass from the smart device to wall.

In an exemplary embodiment, the grille 360 is a magnetically attached grille or outer shell that incorporates light switch electronics that are connected to the smart device 300 via Pogo Pins or other electrical contact mechanisms.

In an exemplary embodiment, the smart device user input component 390 is a touch slider that is a raised and curved capacitive touch switch that is used to change a state of the smart device 300. The switch can be tapped for altering fixture's state (e.g., from ‘off’ to ‘last state’, or from ‘current state’ to ‘off’). There are other multi touch functions with the switch, where a user can hold a specific region of the switch to do certain things, or to turn the fixture to that specific state. There can be countless multi touch gestures for different functions.

In some exemplary embodiments, the power management unit 400 is configured to fit into a conventional light switch box, a conventional power outlet, a conventional Ethernet/Cable port, and/or any other wall electrical junction box.

With regard to the smart device mechanical connector 370 and the power management unit mechanical connector 470, in exemplary embodiments, the anchor points can be things such as, for example, physical fasteners like screws or metal or plastic clips, other forms of clip/hinge/push-pin connector that holds the smart device 300 securely against the power management unit 400, of which is also removable by means of removing the physical fastener, or depressing an indicated surface on the device to disengage any of the other forms of clips/hinges/push-pins. Exemplary mechanical connectors may include magnets, screws, Velcro, tape, and/or male and female connectors. In some exemplary embodiments, the attachment is reversed top to bottom.

FIG. 18 is functional block diagram of exemplary audio processing and wake word engine functionality of an exemplary smart device system 200 in accordance with aspects of the present disclosure. More specifically, the disclosed smart device system 200 is a BUILT-IN ALEXA device. Devices that are “Alexa Built-in” run the Alexa Voice Service themselves, can accept Alexa voice commands directly, and can control other devices, without the need for a separate Alexa device. Devices that “Work with Alexa” are compatible with the Alexa Voice Service. These devices can be controlled by commands spoken to other devices with “Alexa Built-in.”

An Alexa Built-In product, such as the disclosed smart device system 200, includes chipsets, voice processing technologies, and client software that leverages the AVS APIs to enable a native Alexa voice-interface experience, comparable to Amazon Echo. An Alexa Built-In product, such as the disclosed smart device, also includes sound processing for voice-activation “Wake Word”, which is processed on the device, using sound analysis techniques.

Alexa built-in devices, such as the disclosed smart device, provide a hybrid solution that is structured in 3 layers:

(1) Initialization Functions are processed by the disclosed smart device in the device, independently of Amazon systems:
audio processing and noise suppression
algorithm for beamforming
algorithm for acoustic echo cancellation

(2) Stream Communication Functions that are handled by Amazon Alexa SDK packages are installed and configured on the disclosed smart device.

(3) TTS (Text-to-speech) Functions are handled by Amazon Cloud.

Stream Communication Functions are handled by Alexa SDK, which offers an abstraction layer over the Alexa Cloud. Regarding the API, as shown per FIG. 21, the disclosed smart device (3rd party) is responsible for the Audio Processing and for the Wake Word Engine. Most of the other functions are handled by Alexa Cloud and enabled by the Alexa packages that are deployed and configured on the disclosed smart device. In some examples, the disclosed smart device prototype uses the DSP Concepts AWE Engine, running on the ARM-based MCU i.MX8 for the Wake Word Engine function and Texas Instruments preamp IC and Knowles MEMS mics ICs for audio signal processing.

Once the wake word is recognized by the disclosed smart device system, an HTTP/2 stream is created towards the ALEXA CLOUD, passing the audio stream for TTS (Text-to-Speech). For example, the connection function is handled by the Alexa SDK which is locally deployed on the disclosed smart device.

As mentioned, the disclosed smart device system 200 handles the WAKE WORD with a “DSP Concepts” solution, as recommended by NXP (manufacturer of the i.MX8 MCU which is the main processor of the disclosed smart device). This is an MCU-deployed solution, and therefore it is software-based with no specialized hardware required. The disclosed smart device system 200 may, alternatively, use an IC-based solution (hardware based) instead of DSP Concepts software-based function.

In an exemplary embodiment, the smart device 300 may include one or more speakers, a control module including a logic controller/board, electrical modules, an antenna/wireless communications board, a power control module, and one or more antennas. The antenna module may include a plurality of transmitting elements to transmit communication signals or to radiate electromagnetic energy/waves, a plurality of receiving elements to receive communications signals or radiated electromagnetic energy/waves, or one or more antennas, which may be able to do both transmission as well as reception of communication signals or electromagnetic radiation.

In an exemplary embodiment, the smart device 300 may also include a display module, including a panel display with one or more smart switches. The panel display with one or more smart switches 814 is in an aligned position on the front side of the smart device 300. In another exemplary embodiment, the smart switches are assigned various functionalities of the smart device 300, for instance, lighting control.

In an exemplary embodiment, the non-transitory computer readable medium 224 of the microcontroller unit module 220 is loaded with a predefined set of instructions to execute various functionalities, based on the user requirements, to provide better user experience. In another exemplary embodiment, the user could pre-schedule the functions/actions to be performed via the smart device 300, for instance, switch on the light at 5:00 PM every day. Further, the electronic components, such as display module, antenna and power control module cab be disposed on a circuit board of the microcontroller unit module 220.

While various examples of the present invention have been described above, it should be understood that they have been presented by way of example only, and not limitation. Numerous changes to the disclosed examples can be made in accordance with the disclosure herein without departing from the spirit or scope of the invention. Thus, the breadth and scope of the present invention should not be limited by any of the above described examples. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

1. A smart device system for providing high fidelity audio and wireless communications and control, comprising:
a smart device, comprising:
an amplifier module configured for processing digital and analog data for producing high fidelity audio;
a microcontroller unit module configured for wireless communications and control;
at least one speaker communicatively coupled to the amplifier module;
at least one microphone communicatively coupled to the microcontroller unit;
a smart device enclosure;
a smart device electrical connector;
a smart device mechanical connector;
a smart device anti-vibration element; and
a smart device user input component;
a power management unit, comprising:
a power management module configured for supplying power to the smart device;
a power management unit enclosure;
a power management unit electrical connector;
a power management unit mechanical connector;
a power management unit user input switch;
a gang box electrical connector; and
a gang box mechanical connector;
wherein the smart device electrical connector and the power management unit electrical connector are configured to provide for electrical contact of the smart device and the power management unit;
wherein the smart device mechanical connector and the power management unit mechanical connector are configured to provide for mechanical coupling of the smart device and the power management unit;
wherein the gang box electrical connector is configured to provide for electrical contact of the power management unit and a gang box;
wherein the gang box mechanical connector is configured to provide for mechanical coupling of the power management unit and the gang box; and
wherein the smart device anti-vibration element is configured to provide for mechanical coupling of the smart device enclosure to a surface and for reducing mechanical vibrations of the smart device caused by sound vibrations emitted from the at least one speaker.

2. The smart device system of claim 1, wherein the amplifier module comprises:
a digital signal processor;
a digital to analog converter; and
at least one amplifier,
wherein the amplifier module is configured for receiving and processing digital data and outputting analog data for producing high fidelity audio.

3. The smart device system of claim 1, wherein the microcontroller unit module comprises:
at least one processor;
a non-transitory computer readable medium; and
at least one wireless interface,
wherein the non-transitory computer-readable medium is configured for storing a computer program comprising instructions which, when executed on the at least one processor, cause the at least one processor to carry out wireless communications and control.

4. The smart device system of claim 1, wherein the power management module comprises:
a transformer; and
a switching component.

5. The smart device system of claim 1, wherein the smart device electrical connector and the power management unit electrical connector includes a plurality of pogo pins.

6. The smart device system of claim 1, wherein the user input component is configured to cause the smart device to perform at least one of:
control lighting from an electrical junction box communicatively coupled to the smart device;
adjust a volume of the at least one speaker; and
initiate recording of audio input via the at least one microphone.

7. The smart device system of claim 1, wherein the user input component is at least one of: a touch screen, a video screen, a tactile interface, a touch slider, a dimmable switch, a panel display, and any combination thereof.

8. The smart device system of claim 3, wherein the at least one wireless interface comprises at least one of: a wireless communication device, a mesh network card, a radio, an antenna, a wireless repeater, a wireless extender, and any combination thereof.

9. The smart device system of claim 3, wherein the at least one wireless interface is configured for wireless communication using at least one of: WiFi, Bluetooth, radio waves, z-wave, Ethernet, ZigBee, and any combination thereof.

10. The smart device system of claim 1, wherein the smart device mechanical connector and the power management mechanical connector includes at least one of: a docking cradle, a magnet connector, a magnet array, a pivot latch, a clip mechanism, a hinge mechanism, hook-shaped clips, screw fasteners, and any combination thereof

11. The smart device system of claim 1, wherein the gang box that the gang box electrical connector is configured for electrical contact with and the gang box mechanical connector is configured for mechanical coupling with, is at least one of: a one gang (1-gang) single switch gang box, a two gang (2-gang) dual switch gang box, a three gang (3-gang) triple switch gang box, a four gang (4-gang) quadruple switch gang box, a power outlet, a switch box, and a light switch box, and any combination thereof.

12. The smart device system of claim 1, wherein the smart device further comprises at least one passive radiator.

13. The smart device system of claim 1, wherein the smart device further comprises a rechargeable battery.

14. The smart device system of claim 1, wherein the microcontroller unit module is configured to provide for adjusting the high fidelity audio produced and output through the at least one speaker based on external feedback from the at least one microphone.

15. A method for providing high fidelity audio and wireless communications and control using:
a smart device that includes an amplifier module configured for processing digital and analog data for producing high fidelity audio, a microcontroller unit module configured for wireless communications and control, at least one speaker communicatively coupled to the amplifier module, at least one microphone communicatively coupled to the microcontroller unit, and a smart device anti-vibration element; and
a power management unit that includes a power management module configured for supplying power to the smart device;
the method comprising:
receiving, through the at least one microphone, a first user input;
processing, using the microcontroller unit module, the received first user input;
based on the processed first user input, transmitting, using the microcontroller unit module, a first request;
receiving, using the microcontroller unit module, a first response in response to the transmitted request;
processing, using the microcontroller unit module, the received first response; and
based on the processed first response, sending, using the microcontroller unit module, a first control signal to the amplifier module.

16. The method of claim 15, wherein the first user input is at least one of: audio input, a voice activation wake word, a voice command, one or more user-spoken key words, and any combination thereof.

17. The method of claim 15, wherein the first control signal causes at least one of:
playing audio content, adjusting volume control, playing visual content, turning one or more lights on or off, adjusting one or more thermostats, invoking a smart assistant, and any combination thereof.

18. The method of claim 15, wherein:
the smart device further includes a smart device user input component; and
the power management unit further includes a power management unit user input switch;
the method further comprising:
receiving, through the smart device user input component, a second user input;
processing, using the microcontroller unit module, the received second user input;
based on the processed second user input, transmitting, using the microcontroller unit module, a second request;
receiving, using the power management unit, the second request; and
in response to the second request, controlling lighting in electrical contact with the power management unit.

19. A smart device for providing high fidelity audio and wireless communications and control, comprising:
an amplifier module configured for processing digital and analog data for producing high fidelity audio;
a microcontroller unit module configured for wireless communications and control;
at least one speaker communicatively coupled to the amplifier module;
at least one microphone communicatively coupled to the microcontroller unit;
a smart device enclosure;
a smart device electrical connector;
a smart device mechanical connector;
a smart device anti-vibration element; and
a smart device user input component.

20. The smart device of claim 19, further comprising a rechargeable battery, and wherein the smart device electrical connector is configured to provide for recharging of the rechargeable battery, and where the smart device mechanical connector is configured to provide for docking and undocking of the smart device with a docking station.
